(19) United States
(12) Patent Application Publication
(10) Pub. No.: US 2023/0298096 A1
(43) Pub. Date: Sep. 21, 2023

(54) HEDGING SCALING SYSTEM FOR AN INVESTOR EQUITY PORTFOLIO USING A TRADING PLATFORM AND METHOD OF USE THEREOF

(71) Applicant: Mikael Tjarnberg, New York, NY (US)

(72) Inventor: Mikael Tjarnberg, New York, NY (US)

(21) Appl. No.: 17/698,875

(22) Filed: Mar. 18, 2022

(51) Int. Cl. G06Q 40/04

(52) U.S. Cl. CPC G06Q 40/04

(57) ABSTRACT

The present invention generally relates to a hedging scaling system for an investor equity portfolio using a trading platform, more specifically for a platform able to manage and ultimately remove both market risk and idiosyncratic risk in a stock portfolio, the system including either a 0 to 100% hedging scaling system for avoidance of risk or a toggle, and where the custom hedge created can be built from either a financial contract, a reference index, or even a new asset or security customized to eliminate idiosyncratic risk.

### FIELD OF THE INVENTION

The present invention generally relates to a hedging scaling system for an investor equity portfolio using a trading platform, more specifically for a 0 to 100% hedging scaling system for avoidance of both idiosyncratic risk and market risk on a retail or other type of equity portfolio using a trading platform, and more specifically to a trading platform with a capacity by a user to adjust the hedging from a full custom hedge to no hedge.

### BACKGROUND

Different investors own different stocks, aka equity investments and other financial instruments like bonds, commodities, cash, and cash equivalents, including mutual funds and ETFs. As part of these portfolios, investors may hold one, two, or more stocks from one or more industries. The market values of the individual stocks added up represent the collective market value of the portfolio. As such, portfolios are a collection of individual investments that reflect the net financial worth of the owner.

Stocks or equity positions are commonly known as a “position” until sold. They do not expire and may pay annual dividends. Their market value fluctuates over time based on numerous market conditions and factors adding to the value of the investor. For example, in the United States, many retirement positions of most workers include some level of equity position that fluctuates over time with market forces. Also, markets have “indexes,” which are groups of stocks that are not portfolios but instead measurements of the overall evolution of markets. The prediction and anticipation of the value of stocks is an art form that has made many rich but also left many broke.

One of the key problems for professional service providers and traders with ownership of stocks is the downside. As the economy or any set of stocks falls, an owner's worth on their portfolio might drop. Protection on the “upside” or as these positions rise is rarely a problem as income and/or value is generated. However, the drop of value is often the eventuality most want to protect against. The best traders, service providers, and experts are focused on preventing loss and managing any downside drop.

With the banalization of trading Apps, like RobinHood®, in recent years, the purchase and trading of equity position has become more common. As the markets rise, new unwary investors with little to no experience and trusting service providers, such as these Apps invest. As the markets go up, the tide rising all boats gives the unwary investor a false impression of competency. But when markets move down, as they inevitably do, investors might blame the service providers for the downswing.

One tool to guide against downswings which remains difficult to understand and use is the notion of “hedging.” A “hedge” is often considered an advanced investing strategy, but hedging principles are fairly simple. A hedge is a counter-bet designed to offset parts or all the loss of a primary position. For example, a person who bets on horse A in a race might hedge this bet by betting on horse B in the same race. In the event of loss (i.e., horse A does not win), the hedge might, in 25% of the time (i.e., horse B wins), offer a return to offset the loss from the horse A bet. Another example of a hedge is a fire insurance policy on a home. If a fire causes the homeowner to lose their house and belongings, the insurance policy will recover their losses.

One common form of hedging in the world of equity trading is an “option” contract whose value fluctuates over time based on the underlying value of a given position. These contracts exist for many stocks. Generally, options in the most common form have an expiration date (i.e., in 2 months) and a strike price (i.e., $23). These standard options pay proportionally to the value of the underlying position at the expiration date under or above the strike price. Specific options allow a person to “put” (sell) a stock at a fixed strike price, while other options allow a person to “call” (buy) a stock at the fixed strike price. For example, a put option hedge meant for downside protection on a Ford® stock with a $21 strike price will pay $2 if the Ford® stock falls to $19. The option gives the holder the right, but not the obligation, to sell the stock for $21 at the expiration date of the option regardless of Ford®'s stock price on that date.

Puts must be purchased in cash and the premium can be expensive. Not all equity positions have option contracts. And a put contract may only be available for fixed strikes (e.g., $20, $20.50, $21, et cetera.) and at fixed expiration dates (e.g., 30 days, 60 days, 90 days), but in reality, equity trades of investors are not set in such fixed parameters (e.g., equity positions are sold in 27 days, and the market may drop below $20.75). The price and return from an option do not move linearly with the underlying asset price. The price relationship between the option and the underlying asset changes as the price of the underlying asset changes. For example, the price for an at-the-money option might change only 50% as much as the price change of the underlying asset, while the price change for a deep in the money option contract could be 100%. This is a problem when investors want to sell their options before the expiration of the option as this can be desired when the available expiration dates do not match the desired hedge horizon. An option typically gives the buyer or seller the right or obligation to buy or sell 100 shares of a stock for a fixed price, but investors do not own shares only in 100 increments. For the above reasons, it is impossible to use simple puts or calls to offset the portfolio trading risk fully.

Option premiums are higher for assets with higher volatility. If a retail investor wants to protect their whole portfolio with put options, they would have to buy put options on each stock in their portfolio. Due to idiosyncratic risk, the volatility for individual stocks is usually higher than the volatility on a basket of stocks or the volatility for an index, and this means that the total price an investor pays for put options on all their stocks is higher than the price the investor pays for a put option on the whole portfolio. In the current invention, the inventor has found that what is desirable is a way for investors to protect against price volatility for a whole portfolio. Bespoke put options for entire retail equity portfolios do not exist and was created by the inventor as described here-below.

Another portfolio risk managing scenario is if the investor decides to sell equity positions to avoid the potential downside. For example, if an investor believes their stock investments will fall by 10% in the next five days, the investor may liquidate their assets on day one and wait patiently to buy back the positions on day five. One problem with such an approach is tax implications. Namely, when stocks are sold at a gain, this gain becomes taxable income, and the investor must pay capital gain tax. The inventor has invented a way to manage such adverse tax issues. Another problem with the stock sales and repurchases is incurring trading fees and bid-offer trading spreads. As part of the current invention, the inventor found a way to minimize these trading fees and costs.

A third, and by far the most used, risk management strategy for retail equity investors is to use an index instrument, such as a S&P 500 future contract, to hedge their portfolio. But it is a myth and misperception to think that you can hedge a retail equity portfolio with an index instrument. The sections below explain why this type of hedging does not work for retail equity investors and how it on average results in a 60% hedge error.

Above and below it says, options and index instruments are not effective hedges for retail equity investors, and constantly selling and buying back a portfolio as a risk management strategy is nonsensical. Retail equity investors have not had any effective way to manage risk in their portfolios. The inventor and the invention address this issue with a trading system and platform that perfectly hedge retail investors equity portfolios.

For the purpose of this disclosure, a “hedge error” of 0% means that an investor will have made as much money from the hedge as they lost on the portfolio's overall value in the specified period. For example, if a portfolio loses 2%, the hedge will have to be valued at 2% of the portfolio original value for the hedge error to be 0%. A hedge error of 50% means that the hedge only made up for 50% of the loss of the portfolio. In the above example, a portfolio loss of 2% means that when the hedge error is 50%, the hedge was valued at 1%. A hedge error of 100% means that the retail investor did not make any money on the hedge and lost 2% on the portfolio. A hedge error of more than 100% means that the investor lost money both on the portfolio and the hedge.

A retail equity portfolio contains a significant amount of idiosyncratic risk, a risk specific to individual assets. Idiosyncratic risk prevents retail equity investors from effectively managing and hedging risk in their portfolios, and an index hedge creates a 60.1% hedge error on average. The reason for the large hedge error is that an index hedge only hedges the market risk in retail equity portfolios, but not the idiosyncratic risk component, which is significant. What is needed for retail equity investors is a new hedging scaling system for their equity portfolios using a trading platform where a person can easily regulate and scale the amount of risk they want to cover and select any hedge amount of 0-100% for their portfolio. This system should address the idiosyncratic risk issue in retail equity portfolios and create a perfect hedge for retail equity investors that always achieves a 0% hedge error. Such a system does not exist and was created by the inventor and is described here-below.

The sections below explain the theoretical foundation for the invention and why retail investors need it to hedge their portfolios. Specifically, they show that because of the idiosyncratic risk present in retail equity investors' portfolios, retail investors cannot hedge their portfolios with index products, such as S&P 500 ETFs, S&P 500 index futures, or S&P 500 index options.

### SUMMARY

The present invention generally relates to a hedging scaling system for an investor equity portfolio using a trading platform, more specifically for a platform able to manage and ultimately remove both market risk and idiosyncratic risk in any stock portfolio, the system including either a 0 to 100% hedging scaling system for avoidance of risk or a toggle, and where the bespoke hedge created can be built from either a financial contract, a reference index, or even a new security or asset customized to eliminate market risk and idiosyncratic risk.

### BRIEF DESCRIPTION OF THE DRAWINGS

The present disclosure features are novel and set forth with particularity in the appended claims. The disclosure may best be understood by reference to the following description taken in conjunction with the accompanying drawings, and the figures that employ like-reference numerals identify like elements.

FIG. 1 is a schematic diagram of a variable hedge risk system for hedging investment positions in an equity portfolio using a trading platform according to a first embodiment of the present disclosure.

FIG. 2 is the schematic diagram of a variable hedge risk system for hedging investment positions in an equity portfolio using a trading platform of FIG. 1, wherein the trading desk includes a step of creating a bespoke reference index for use by the product according to another embodiment of the present disclosure.

FIG. 3 is the schematic diagram of a variable hedge risk system for hedging investment positions in an equity portfolio using a trading platform of FIG. 1 or 2 but including a securitization or asset module according to a third embodiment of the present disclosure.

FIG. 4 is the schematic diagram of a variable hedge risk system for hedging investment positions in an equity portfolio using a trading platform of FIG. 1, 2 or 3, where the bespoke reference index, asset or security for option includes the creation of a select strike and/or option quote to retail investor according to one embodiment of the present disclosure.

FIG. 5 is the schematic diagram of a variable hedge risk system for hedging investment positions in an equity portfolio using a trading platform of FIGS. 1-4, where the retail investor posts a collateral according to another embodiment of the present disclosure.

FIG. 6 is a schematic diagram of a computer network where the systems of FIGS. 1-5 can reside.

FIG. 7 illustrates the hardware elements that support an electronic online trading system of FIGS. 1-5 according to an embodiment of the present disclosure.

FIG. 8 is a diagrammatic representation of the software connection between the platform and the investor software interfaces.

FIG. 9 is an illustration of the amount of idiosyncratic risk in equity portfolios with a different number of stocks.

FIG. 10 is a scatter plot of hedge errors for stock portfolios hedged with S&P 500 index for five days.

FIG. 11 is the average hedge error for equity portfolios that are hedged for five days with the S&P 500 index.

FIG. 12 is the average hedge error for five stocks equity portfolios hedged with S&P 500 for 1-30 days.

FIG. 13 is a scatter plot of hedge errors (five stocks hedged with S&P 500 for five days) versus portfolio loss in %.

FIG. 14 is a scatter plot of hedge errors for five stock portfolios (MSFT, AAPL, GOOG, AMZN, TSLA) hedged with S&P 500 for 1-10 days.

FIG. 15 is an illustration of one of the core inventive concepts of FIGS. 1-5 as articulated as part of an overall process for protecting a stock portfolio according to an embodiment of the present invention.

### DETAILED DESCRIPTION

According to Randy Frederick, the head of trading at Charles Schwab, the largest U.S. equity broker, there is an unfilled market need for better portfolio hedging products: “What I hear most from customers is, ‘How can I stay in the market when it gets rocky and reduce my risk without closing my positions?’” An equity portfolio contains a significant amount of idiosyncratic risk, a risk specific to individual assets. Idiosyncratic risk prevents equity investors from effectively managing and hedging their portfolios.

Most of the volatility in their portfolios comes from idiosyncratic risk and as this risk is uncorrelated with other assets, an index product, such as S&P 500 futures or an ETF, hedges on average only 39.90% of the risk in their portfolios. The index hedge is ineffective on average, but its most significant issue is the high level of uncertainty around the actual outcome of a specific hedge. Research has shown that the average hedge effectiveness of 39.90% has a standard deviation of 53.59%. This means that if an equity investor uses an index product to hedge their portfolio, the hedging result, as seen in FIG. 10, is random. The hedge error could fall anywhere in the 0-100% range, or even worse, the hedge and the hedged portfolio could move in the same direction, and both lose money (a hedge error of more than 100%). The idiosyncratic risk in equity portfolios makes it impossible for investors to manage risk effectively with the financial products currently available.

Below is described for an equity investor, even a retail equity investor, a new hedging scaling system for their equity portfolios using a trading platform where a person can easily regulate and scale the amount of risk they want to cover and select any hedge amount from 0 to 100% for their own investment portfolio. This system addresses the idiosyncratic risk issue in equity portfolios and creates a custom hedge for equity investors giving them an effective 0% hedge error.

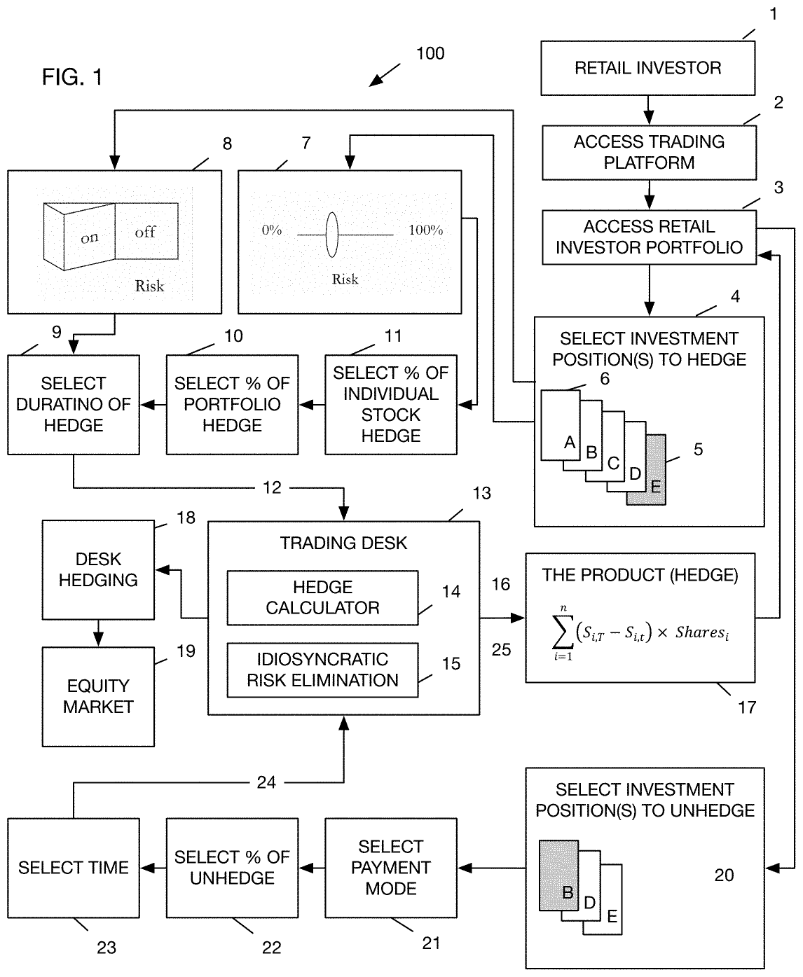

The Risk Switch hedge (“The Product”) shown as 17 on FIGS. 1-5, is a financial product that perfectly hedges investors' equity portfolios. It allows investors to temporarily “switch off” their risk and remove all their exposure without selling or touching their positions. The Product 17 as part of a system 100 hedges 100% of the risk in an investor's portfolio as illustrated by a switch 8 at FIGS. 1-5, or if the investor uses the “dimmer” option 7 as illustrate at FIGS. 1-5, on the trading platform of the system 100, it reduces risk in any increment from 0 to 100%, instead of switching it off completely.

The Product 17 (the hedge) is a personalized and bespoke hedging product that always has a −1 correlation (moves perfectly inversely with the hedged portfolio) with the equity portfolio it is intended to hedge and protect on the downside. The Product achieves the −1 correlation because the trading platform and scaling system create a bespoke financial contract, asset, security, or reference index for each retail equity investor. A customized hedge is necessary as each investor portfolio is different, and it is the only way to address the issue with idiosyncratic risk. Bespoke hedges for entire retail equity portfolios do not exist and was created by the inventor as described here-below.

The total average option premium the investor must pay for buying, for example, put options for every stock in their 10-stock portfolio is much higher than the option premium the same investor would have to pay for one put option on their entire portfolio. Bespoke put options for entire retail equity portfolios do not exist and was created by the inventor as described here-below.

A retail equity investor encounters a unique problem when they try to hedge their portfolio primarily because their equity portfolios commonly contain only a limited number of stocks. For example, the stock price of an individual stock like Apple® fluctuates in value with the rest of the market (market risk) and from Apple-specific events (specific risk or idiosyncratic risk). A Federal Reserve interest rate announcement, for example, is an event that affects the whole market and can impact all stocks, while an announcement by Peloton®'s CEO that they have temporarily halted production of new exercise bikes due to low demand only affects Peloton's stock price. Specific risk is random and does not correlate with other events or assets.

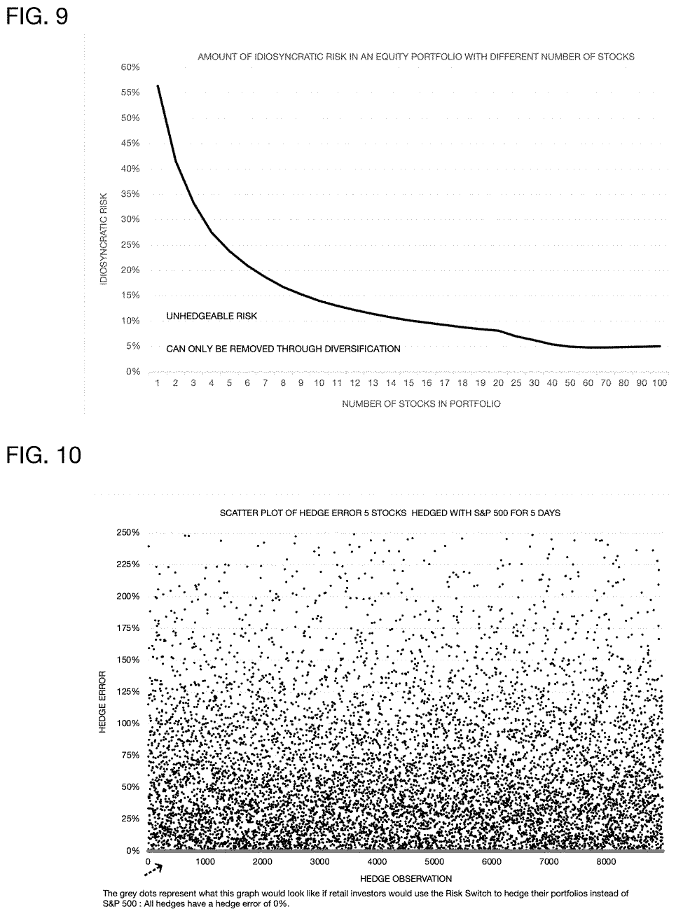

Such an announcement impacts the stock price of Peloton®, but the stock prices of companies B, C, D, et cetera may not move. As companies' stock prices do not move together from these specific events, we say that company A's stock price move from this event is uncorrelated to the price moves for other companies. That is, the stock prices for companies do not move together from firm-specific events. A hedge requires correlation for it to work. The hedge must move with the hedged asset, either in the same direction (hedge is a short position in the asset) or opposite direction (hedge is a long position in the asset). While investors cannot hedge specific risk, they can reduce or eliminate it by diversifying and adding different stocks to the portfolio, as many random events cancel each other out (some lose and some gain). However, as shown in FIG. 9, retail investors tend to have too few stocks in their portfolios to benefit from diversification, and a large portion of their risk is idiosyncratic. Thus, any index hedge they might use will produce a significant hedge error. It will only hedge the price movements from general market events, not idiosyncratic events, and therefore, the hedge will work very poorly.

### Example 1

Investor A has invested in two stocks: a $10,000 investment in Apple® and a $10,000 investment in Peloton®. They hedge their position by selling (shorting) $20,000 of an ETF that tracks the S&P 500 index. The goal of the hedge is for gains on their S&P 500 hedge to fully offset any losses from their Apple® and Peloton® investments. Two events that impacted their portfolio occurred in the following two days. First, news about an escalation in the political tension in Ukraine impacted all stocks, and both Apple®'s and Peloton®'s stock lost 2%. The S&P 500 index also fell 1.92% as this news broadly affected the market. In this case, investor A lost $400 on their Apple® and Peloton® investments and gained $384 on the S&P 500 hedge, and the hedge error was only 4%. The hedge worked well as it gained in value by almost the same amount as the portfolio (Apple® and Peloton®) lost in value. The next day, Peloton®'s CEO announcement of lower bike demand came out, and as a result, the stock price of Peloton® fell by 20%. But as this was a specific event related to Peloton® only, the rest of the market was not impacted by the event, and the S&P 500 index was unchanged. Investor A lost $2,000 on their Peloton® investment from this event but made no money on their hedge. In this case, the hedge error was 100% as the hedge did not make up for any of the losses on the Peloton® investment.

### Example 2

Idiosyncratic risk is particularly an issue for retail equity investors and an index hedge, such as an S&P 500 position, often works poorly for them. Here, investor A has only two stocks in their portfolio, Tesla® and Microsoft® (with a $10,000 investment in each stock). On the other hand, Hedge Fund B has 100 different stocks in its portfolio (with a $1,000,000 investment in each stock). Investors A and B hedge their whole portfolio with a short position in the S&P 500 (investor A shorted $20,000 and investor B shorted $100,000,000). Only one firm-specific event impacted investor A's portfolio (Tesla® did not meet the production goals of their model Y car), but 75 different firm-specific events impacted Hedge Fund B's portfolio. Investor A's event had a negative impact on their Tesla® investment. In contrast, 39 of the 75 events for investor B had a negative impact, and 36 events positively impacted investor B's stock portfolio. All events for investors A and B were company-specific (idiosyncratic) events that only impacted the companies in their portfolios (news about company X only impacted company X, et cetera, but not the rest of the market). Therefore, the S&P 500 did not move at all. All events led to a 5% movement in the stock price for the affected company, down if it was a negative event and up if it was a positive event. As a result, investor A lost 2.5% of their portfolio value (5% loss on $10,000 Tesla® investment, $0 loss on Microsoft® investment) and gained 0% on their S&P 500 hedge. Investor B on the other hand only lost 0.15% in total (5% loss on 39 investments of $1,000,000, and 5% gain on 36 investments of $1,000,000). Investor B only lost 0.15% of its portfolio value because investor B had many stocks in their portfolio and benefitted from diversification. Some firm-specific events were adverse, but others were positive, and they largely canceled each other out. 39 investments lost money, while 36 investments gained, and therefore, the net effect on B's portfolio was small. The firm-specific events did not impact investor B as much as it had many different stocks. The total impact on the portfolio (from idiosyncratic risk) was muted because of the offsetting events. This shows that idiosyncratic risk has a small return impact on a well-diversified portfolio, and therefore, an investor with many stocks in their portfolio does not need to hedge or worry about idiosyncratic events as the price movements from these events cancel each other out.

Price movements from specific events is a more defined issue for what is quantified as ‘retail’ investors (with a small number of stocks in their portfolios) and less of an issue for institutional investors (with many stocks in their portfolios). In a randomized event where flipping head is worth +5% and flipping tail is worth −5%, once a person flips once (one stock), there is a 50% chance that you will lose 5% (tail). Once the coin is flipped 100 times, the statistical variation from the mean (i.e. 0%) tends to draw to the average. This means that as retail investors increase the number of stocks in their portfolios, the probability that idiosyncratic events will be offsetting increases.

Above it says, an investor cannot hedge idiosyncratic risk as it only affects one company (uncorrelated to other assets), and idiosyncratic risk can be diversified away by increasing the number of different stocks in the portfolio. Therefore, small investors, such as retail investors, have a limited way to hedge risk in their portfolios. A portfolio with a small number of different stocks has a substantial idiosyncratic risk component. This risk is uncorrelated to the market and other assets. Due to idiosyncratic risk, an index hedge (such as S&P 500 or an ETF) is a very poor hedge for any retail portfolio.

FIG. 9 quantifies the idiosyncratic risk for portfolios with different numbers of stocks. It describes the volatility of the “residual return” that is not explained by the market factor (beta). There is no direct link between idiosyncratic risk and the actual hedge performance for a particular hedge. A volatility measure only summarizes the distribution of residuals, but investors are concerned about the hedge performance in their specific case and not an “average” or typical hedge performance. FIG. 10 shows the distribution of hedge errors and gives a clear picture of what happens when retail investors hedge their portfolios with an index instrument (S&P 500 in this case). Investors do not know where their hedge will end on the chart and this uncertainty disqualifies the index hedge as a suitable tool for retail investors.

FIG. 10 shows the hedge performance for 50,000 retail portfolios with five different randomly generated stocks, hedged with a beta weighted index position (results are almost identical without a beta adjustment) over a randomly selected 5-day period. To remove noise, hedge performance is only displayed in the 8,988 cases (out of 50,000) where the portfolio lost more than 1% during the 5-day hedge period. As indicated above, a hedge error of 0% means that the retail investor made as much money from the hedge as they lost on the portfolio. A hedge error of 50% means that the hedge only made 50% of the loss of the portfolio. A hedge error of 100% means that the retail investor did not make any money on the hedge and only lost on the portfolio. A hedge error of more than 100% means that the investor lost money on both the portfolio and the hedge (18.75% of the hedge outcomes).

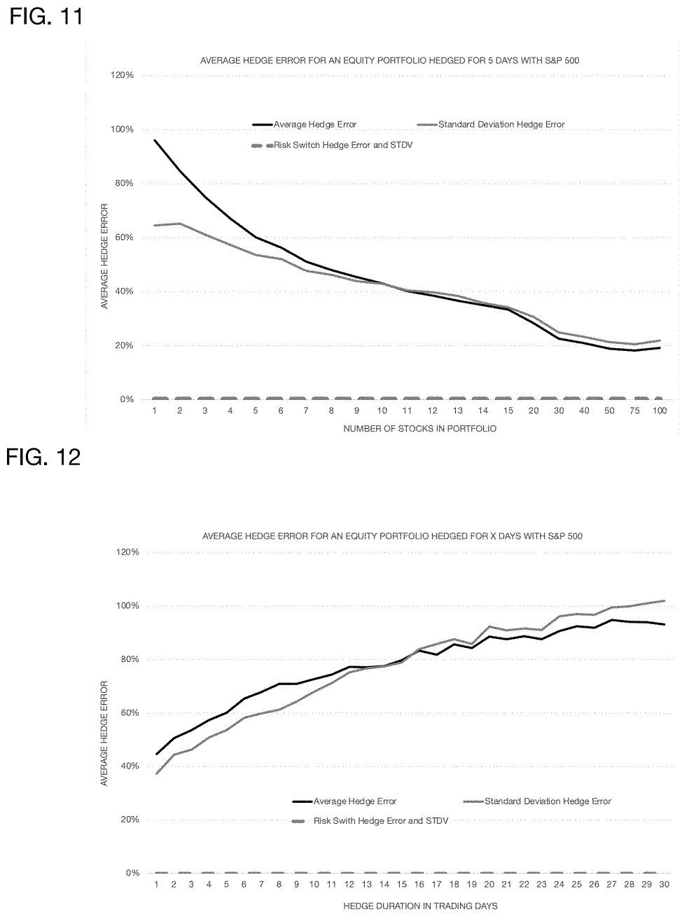

The average hedge error in FIG. 10 is 60.10%, and the standard deviation of the error is 53.59%. FIG. 11 and FIG. 12 show these summary statistics of hedge errors for portfolios with different stocks and over different hedge horizons. FIG. 11 illustrates a quantification of the size and variation of the hedge error for portfolios with a different number of stocks. The average error and the variance of the error decrease as the number of stocks in the portfolio increases. The dashed line represents the hedge error when investors hedge their portfolio with The Product 17 and shows that regardless of the number of stocks in the portfolio, the hedge error is always 0%.

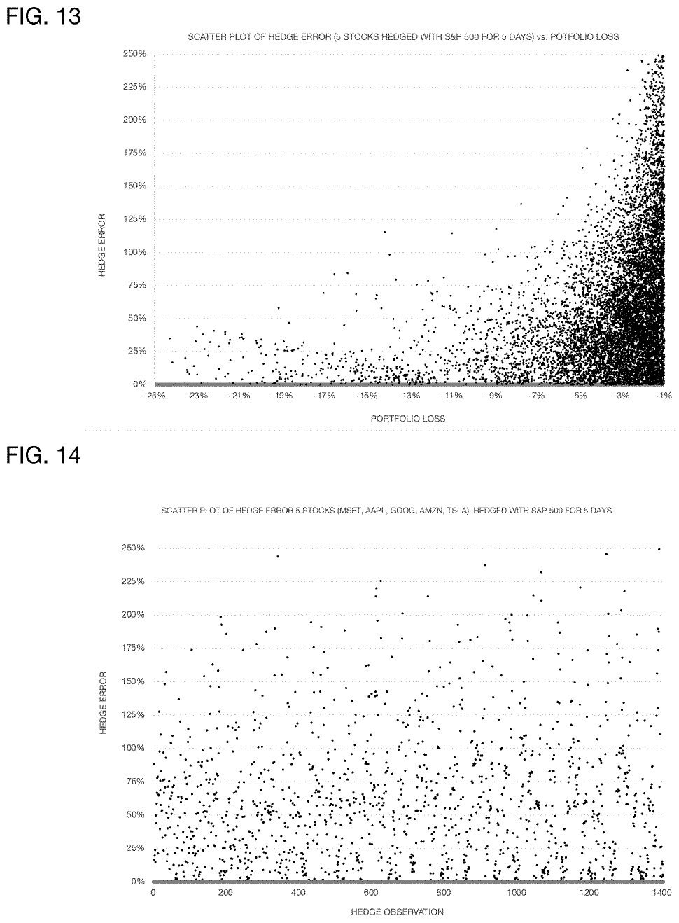

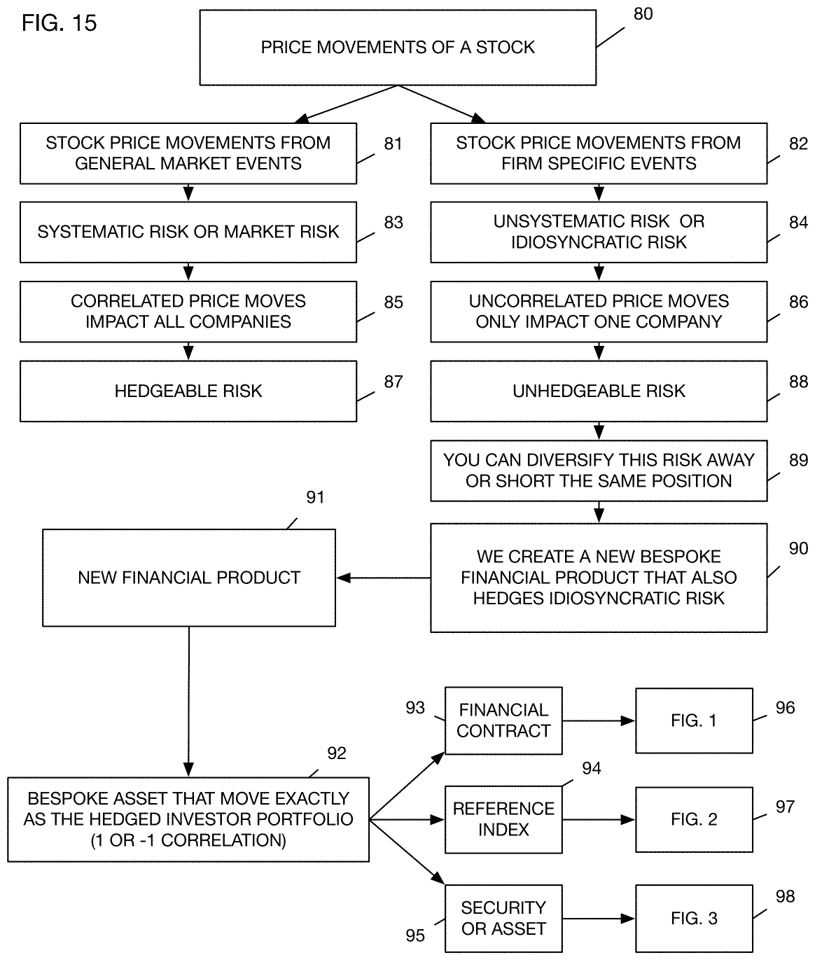

FIG. 12 illustrates the quantification of the size and variation of the hedge error for a portfolio with five stocks hedged with S&P 500 for a certain number of days. The average error and the variance of the error are increasing with the horizon of the hedge. The dashed line shows the hedge error when investors hedge their portfolio with The Product 17, meaning the hedge error is always 0% regardless of the duration of the hedge. FIG. 13 shows the distribution of the hedge error at different portfolio losses. FIG. 14 shows the hedge performance for a fixed portfolio, in this case, the five largest stocks in S&P 500 (MSFT, AAPL, GOOG, AMZN, TSLA), for every possible 1-10 days hedge duration combination in the last three years. The scatterplot shows all hedge outcomes where the portfolio lost more than 1%.

The Product (the hedge) 17 FIGS. 1-5 is a bespoke hedging product that always has a perfect −1 correlation with the retail equity portfolio it is intended to hedge. It is a hedge with a 0% hedge error. The Product achieves the −1 correlation because the trading platform and scaling system create a bespoke financial contract, asset, security, or reference index for each equity investor, and the return on this bespoke asset inversely mirrors or mirrors the return in the specific portfolio it is meant to hedge. Financial innovations are often about creating products with a Beta of 1 (index products) or a correlation of as close to −1 as possible (hedging products). The Product 17 FIG. 1-5 is a financial hedging product with a perfect −1 correlation.

An investor who desires to obtain a diversified long market position cannot buy 500 individual stocks to limit issues. An investor who wants to invest $10,000 would only have $20 on average for each stock, and most stocks do not trade in such low increments. Additionally, the investor must pay 500 different trading commissions and 500 mid-offer spreads. If the investor temporarily wants to exit the market for one week, in such a case, they would need to sell all 500 stocks on day one and buy them all back one week later. This would result in 1,000 more trading commissions and 500 bid-offer spreads.

Some securities track baskets or indexes of stocks, such as the S&P 500 index and various ETFs. With these securities, investors only need to buy one security, but they get the same broad market exposure as someone that buys 500 different stocks. Index securities and index assets address market Beta. That is, if the overall market goes up, ETFs that track indexes such as the S&P 500 also go up and vice versa. Investors with diversified portfolios can effectively use these index products to hedge their portfolios. They can do this as both the index and diversified investors' portfolios contain little or no idiosyncratic risk. However, as seen above, index products do not hedge individual retail equity portfolios as these portfolios are not sufficiently diversified and contain a large portion of idiosyncratic risk.

Hardware and Platform

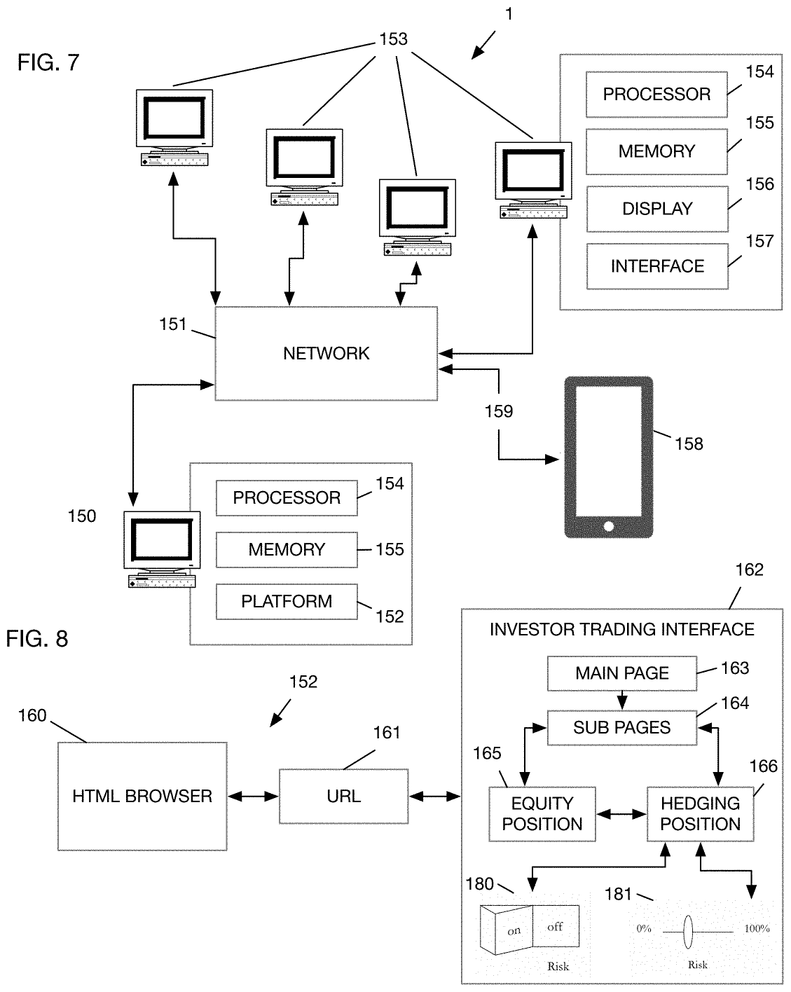

Since some materiality must be shown in association with the new hedging scaling system FIGS. 1-5 for a retail investor equity portfolio using a trading platform, one must understand that system and associated software is implemented on a system designed for executing trades of financial instruments, much like banking software tools is of critical importance to national order. These systems must be secure, reliable, and easy to maintain. Shown at FIG. 7 is one of the numerous potential hardware configurations capable of hosting and executing the trading platform and the method described herein. In its most straightforward and most secure configuration, FIG. 7 shows a remote server 150 or any other type of computing device connected either wirelessly, via landlines, or in any way to a network 151. A plurality of personal computers 153 such as Personal Computers (PC's), laptops, handheld devices like a tablet, a web-enabled phone, or any other web-enabled device with a computer processor 154 is in turn connected to the network 151.

The server 150 or the personal computers 153 can broadly be described as having a processor 154 connected to a computer memory 155. While a display 156 is generally found on the server 150 but is not needed, the personal computers 153 do require some type of computer display 156 connected to the computer processor 154 for interaction with potential investors using the platform 152 hosted in the hardware shown at FIG. 7. The display 156 helps the investor (not shown) navigate over a software interface 157 as shown at FIG. 7 to display different information in the computer memory 155 by the computer processor 154 over the interface 157.

Within the scope of this disclosure, the term computer display 156 includes more than a screen or other visual interface; the term display is designed to include any interface capable of interacting with an investor, whether visual, oral, touch, or any other interface. A personal computer 153 also includes running as part of the memory 155 and displayed on the computer display 156 an investor interface 157 and is connected to the computer processor 154. In one embodiment, the processor 154 executes an operating system (not shown) and an associated HTML web-enabled browser (not shown) capable of displaying to an investor using a trading and management platform 152 residing on a network-enabled server 150 connected to a network 151 like the World Wide Web also called commonly ‘the Internet.’ The term network is used as part of this disclosure and encompasses broadly any computer network, over hardware, software, or wireless such as a Local Area Network (LAN), or any other network where the platform can be found to trade financial instruments, like for example equity positions and hedging options in a secure environment.

The trading platform 152 also includes a network-enabled server 150 has, for example, a server processor 154 with a server memory 155 for executing a trading platform 152. As shown in FIG. 8, the trading platform 152 can be connected to the investor software interfaces 162 for each of the plurality of personal computers 153 via the network 151. In association with wireless networks physical networks, for operating software to help give material form to the new biddable financial instruments, these computers are systems for trading the biddable financial instruments. These systems, platforms, and software and their associated functions are described hereafter.

What is described below is a risk management system on a trading platform 100, as shown generally for trading equity instruments and hedge positions hosted on the structure shown at FIG. 7 including a network-enabled server 150, the trading platform 100 comprising a plurality of user personal computers 153 each with at least a computer processor 154 with a computer memory 155 for executing a software 162 shown at FIG. 8 generally in the computer memory 155 by the computer processor 154, a computer display 156 and interface 157 connected to the computer processor 154, and a computer connection illustrated by arrows to a network 151. The software platform 152 in each of the computer processors 54 is an investor software interface 162 of a remote trading platform 152 as shown at FIG. 8 and at least one network-enabled server 150 connected to the network 151 with a server processor 154 and a server memory 155 for executing the platform 152.

As shown in FIG. 8, the trading platform 152 is connected to the investor software interfaces 162 via the network 151, URL web site 161 using an HTML Browser 160 often located the software layer in the memory 155 of the personal computer 153. The plurality of personal computers 153 and platform 152 includes several functional modules shown in other figures. Platform 152 also includes, as shown, the main access page 163, which allows users to surf subpages 164 to access equity positions 165 or hedging positions 166.

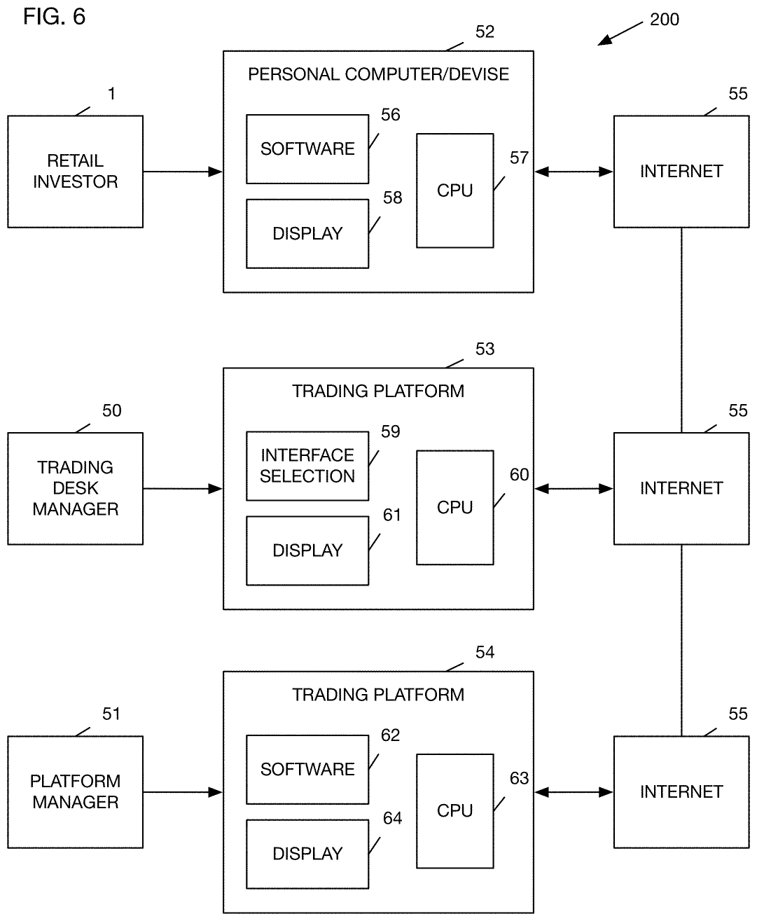

FIG. 6 describes a computer network 200 where the systems of FIG. 1-5 can reside. With the arrival of modern times and computers, online platforms 52, 53, and 54 are connected at the same or different locations to a network, such as the internet 55. A different person accesses each computer, either a retail investor one from a personal computer 52 in their home, a Trading Desk Manager 50 using a trading platform 53, or any other type of computer to operate a Trading Desk 13 as shown at FIGS. 1-5 and other platform managers 51 (shown as a single individual but contemplated as any number of computers or individuals) using a hedging instrument platform 54. In each of these computers, a CPU 57, 60, and 63 are used to process information input from the users 1, 50, or 51 via an interface 59 or a software 56, 62 guided using a display or other tools 58, 61, or 64.

Today the concept of software operating within hardware is migrating away from this fixed structure. Cloud computing and data storage allows interconnected hardware elements like cell phones, wireless tablets, portable computers, and even onboard memories to act as part of more extensive data structures and systems. While one hardware configuration is shown as the currently preferred embodiment, one of ordinary skill will recognize that there will be a migration away from these simple structures with time. For example, new software platforms may allow the different actors to retain local control over some issues. The following technology is not limited to one hardware configuration.

Software

FIG. 1 is a schematic diagram of a system for hedging an investment position in a portfolio using a trading platform according to a first embodiment of the present disclosure. The image is only illustrative of one possible embodiment described in more detail above and below. An investor, shown for example as a retail investor 1 accesses a trading platform 2 where their portfolio 3 is found. The portfolio can include any type of asset or equity. The retail investor will then select any number of investment positions 4 in their portfolio to hedge. As shown in 4, a portion of the portfolio illustrated at 5 can already be hedged, while others may not be, as defined by the white pages 6.

The Product button 8 in FIGS. 1-5 is an example of the interface retail equity investors could use to hedge 100% of the risk (all stocks) in their portfolio 4 using 8 in FIGS. 1-5. The Risk Dimmer Switch or scaling system 7 in FIGS. 1-5 is an example of the interface retail equity investors could use to hedge, for example, 45% of the risk in their portfolio (all stocks) 4 using 7, and 10 in FIG. 1. The Risk Dimmer Switch 8 in FIGS. 1-5 and The Product 17 in FIGS. 1-5 can also hedge individual stocks in portfolio 4 using 7 and 11 at FIGS. 1-5.

A commercial trading tool has a “hedge” button or interface to enable the hedging function in one embodiment. This can, for example, be a “Risk Switch” button 8, or a “Risk Dimmer” switch 7. This button can also be analogized with a freeze function or a panic function for an investor to protect their portfolio using this invention against market uncertainties and harm. In yet another embodiment, the button can be made in color and include wording; for example, green to unhedge and red to hedge indicated that the hedging had been done. These interfaces make it clear to investors that they can use these buttons, switches, toggles, et cetera to hedge or reduce risk in their portfolios. The invention allows at 8 for the retail investor to hedge their entire portfolio. The investor can also hedge all positions by setting 7 to 0% using the dimmer interface. In another embodiment, the word “Risk” is replaced with “Hedge.”

As shown at FIGS. 1-5, the interface allows at 7, 9, 10, and 11 for to select a portion of a position to hedge (for example, only 5 out of 10 stocks), to select for a large segment a % of the hedge (for example only 25% of the whole portfolio value), and to select the type of hedge duration and strike price (for example protection below 2% loss, at a fixed amount of loss, or only for a week or two). The interface allows the investor only to select a % of their position to hedge (for example, only 50% of the risk for all stocks in their portfolio) using 10, to select for a segment to hedge (for example, only 4 out of 10 stocks) using 11, and to select the type of hedge duration (for instance hedge for three days, or 2 hours) using 9.

The Trading Desk 13, as shown at FIG. 1, includes an interface where the Retail Investor 1 will ultimately transfer orders to hedge at the requested combined parameters 12. The Trading Desk 13 consists of a hedge calculator 14 capable of calculating the proper hedge as determined in the formulas and inputs in 4, 5, 6, 7, 8, 9, 10, and 11 provided above. All risk, including idiosyncratic risk 15, is eliminated by the Trading Desk 13. The hedge calculator creates an individualized financial contract or asset 17 that inversely mirrors or mirrors the investment positions the investor elected to hedge with the combined parameters in 12. The Trading Desk 13 sends 16 the individualized hedge 17 to the retail investor. This hedge has a −1 correlation with the investment positions the investor selected to hedge as represented by the combined hedge parameters 12, creating a 0% hedge error.

The Trading Desk 13 relies on internal or external counterparties 18 and various hedging instruments 19 to manage the desk's risk. The Trading desk 13 might use index products such as S&P 500 to hedge the risk total risk in the client portfolio (total hedges from all retail equity investors) or might hedge each individual contract, asset or security 17 it creates separately by using single name hedges for each underlying security in the hedge 17 it provides for each retail investor. The trading desk can also hedge the bespoke hedges it creates for the retail equity investors by selling or buying bespoke and customized portfolio hedges to/from other investors or trading desks. The Desk Hedging 18 could also use any combination of these hedging methods or other hedging methods.

Another essential feature of the invention is the rapidity of execution and the timing aspects of the hedge portions of the portfolio. As part of the embodiment of this invention, standard tools to accelerate trading are implemented to help provide the investor with the rapid capacity of execution. The platform may be populated with preferred settings to default or linked with an external portable device to enable trade.

These systems include automated interfaces portable handheld devices with software apps or browsers to access the different tools and software to run the above-described invention. One of ordinary skill in the art of stock trading, options trading, or hedging will know that while one type of system is shown, what is disclosed to operate in conjunction with the above-described invention is the use of any system, automated and manual, where the invention can be executed.

Hedges are constructed from many types of financial instruments, including stocks, ETFs, insurance, forward contracts, swaps, options, many types of over-the-counter and derivative products, futures contracts, indices or repos. A hedge is often defined as taking a position in a market to offset and balance against the risk adopted by assuming a position in a contrary or opposing market or investment. Commonly, traders refer to buying the contrary or opposing market position as “getting a hedge” on a position. Still, the initial position is hedged by taking a new position.

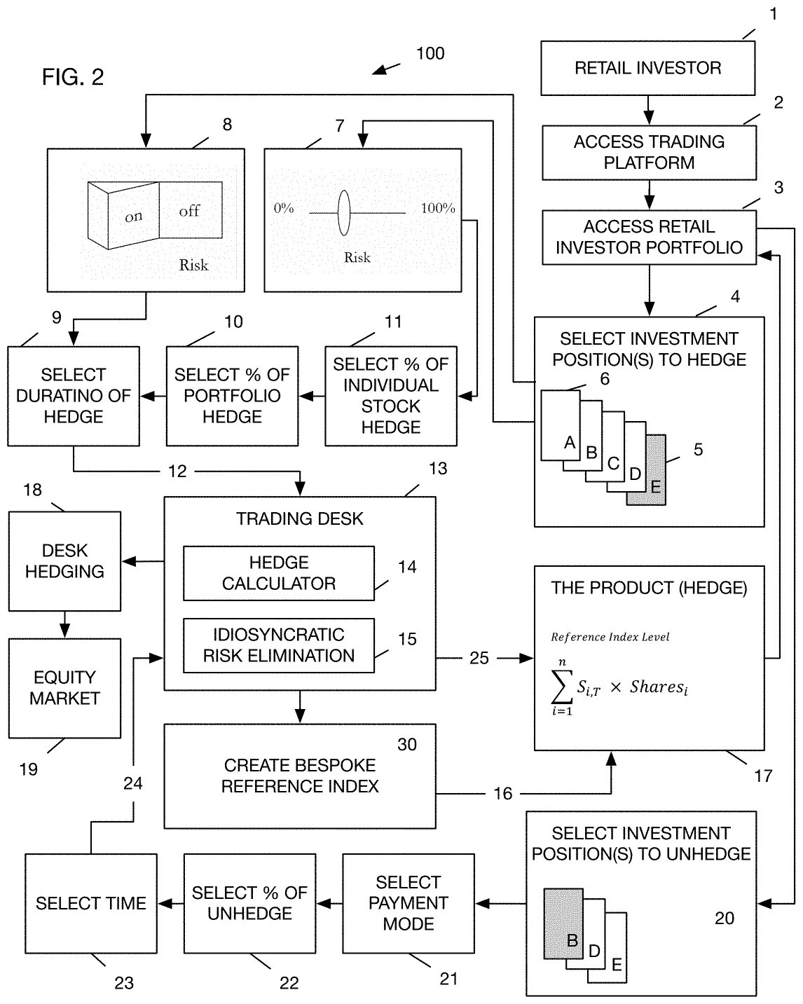

The Trading Desk 13 provides a hedge 17 and returns the hedge instrument or value to interface 3 as shown at FIG. 1. The investor can hedge a new position 4 or unhedge 20 any portion of their portfolio already hedged using the functions shown at 21, 22, and 23. For example, an investor can hedge their whole portfolio except their IBM stocks in 4 in the morning and later the same day can decide to hedge also their IBM stocks using the portions 4, 7, 9, 11 of the diagram of FIG. 1 or can unhedge back out of a part of the position 20 using 21, 22, and 23. Once the retail investor sends the final unhedge parameters 24 to the Trading Desk 13, the Trading Desk 13 will terminate the selected hedge and issue or request a payment 25 to settle the hedge contract 17 or parts of the hedge contract 17 the investor has chosen to unhedge. At element 21, a mode of payment for removing the hedge is selected. While the payment of fees is not explicitly shown in this figure, what is contemplated is the payment of a fixed or variable fee to a broker or the Trading Desk offering a service to enable, disable, or change a hedged position. The payment to close out the hedge contract 17 by either paying or receiving the current contract or asset value. Another alternative for 17, instead of using a financial contract, is for the trading desk to create a bespoke reference index 30 as shown at FIG. 2. In this case, the cash flows are the same as for the financial contact alternative as the retail investor pays or receives the difference between the reference index value at the time the hedge was created and the value at the time the hedge is unwinded. The trading desk can use bid prices, offer prices, or mid prices for the underlying securities to determine the index level.

The Trading Desk 13 at FIG. 2 creates a bespoke reference index 30 that has a 1 correlation with the portfolio the retail investor has selected to hedge. The reference index 30 contains the same stocks as the retail investor has selected to hedge. For example, if investor A has selected to hedge 12 shares of Tesla® and 8.2 shares of Microsoft®, the reference index will contain 12 shares of Tesla® and 8.2 shares of Microsoft®. The reference index can contain any fraction of a stock, for example, ⅓ of an IBM® share and 8 and ⅝ shares of JP Morgan®. The retail investor is short the reference index (establishing a −1 correlation). The trading desk pays the retail investor any losses in the reference index during the hedge period, and the retail investor pays the trading desk any gains. The reference index created in 30 can also contain a short position in the hedged stocks, and in this case, the hedge 17 is a long position in this reference asset. The reference index could also use leverage. For instance, if the index is leveraged 10 times, if a retail investor wants to hedge 100 shares of Apple®, the reference index contains 10 shares of Apple®. The trading desk then pays the retail investor 10 times the losses in the reference portfolio, and the retail investor pays the trading desk 10 times the investment gain in the reference portfolio.

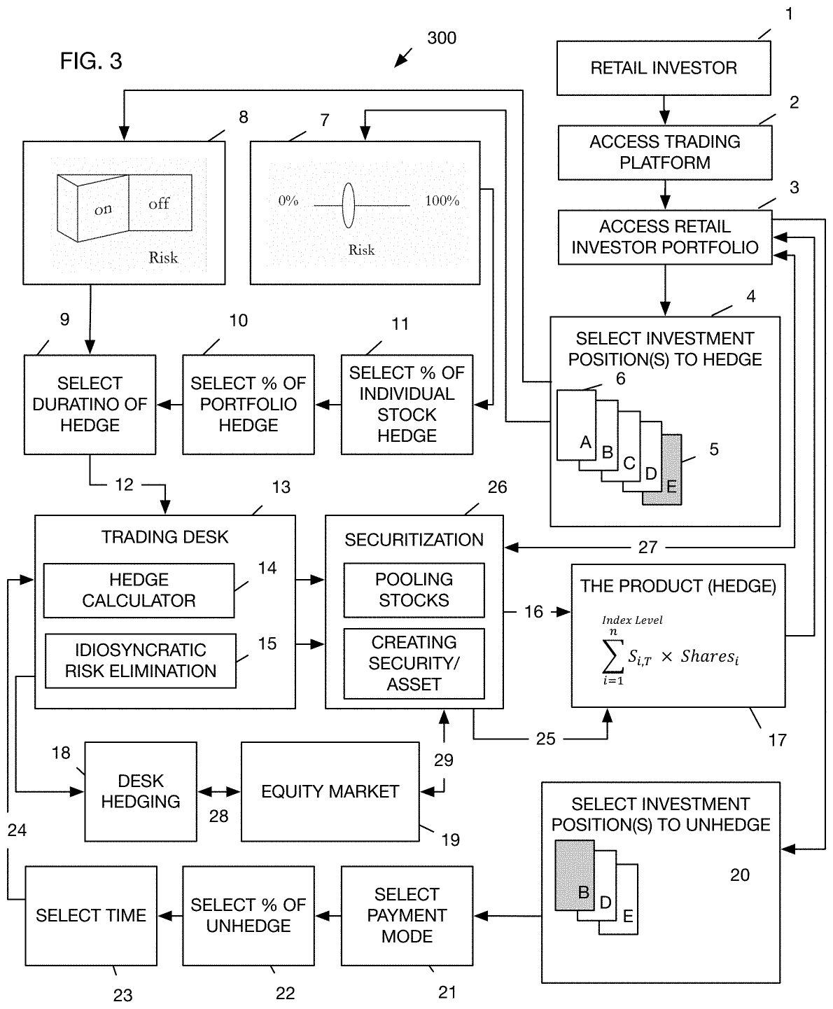

In a third embodiment, the Trading Desk 13 in FIG. 3 creates a bespoke asset or security with a 1 correlation with the portfolio the retail investor has selected to hedge. The trading desk creates an index security or asset 26 FIG. 3 which contains the same stocks as the retail investor has selected to hedge. For example, if investor A has selected to hedge 10 shares of Apple® and 12 shares of Microsoft®, this index security will contain 10 shares of Apple® and 12 shares of Microsoft®. The index security can also contain any fraction of a stock, for example, ⅔ of an Apple® share and 12 and ⅓ of Microsoft® shares. To create the security during the securitization process 26, the trading desk can use stocks from its own inventory, borrow stocks 27 from the retail investor or borrow stocks from the equity market 29. After the index security is created, the retail investor will obtain a short position in this security (establishing a −1 correlation). The asset or security can be traded on an exchange or via over-the-counter. The payment to the retail investor for selling this asset or security can be made at different times as per the agreement between the trading desk and the retail investor. The bespoke asset or security can also contain leverage in the same way the bespoke reference index in FIG. 2 can.

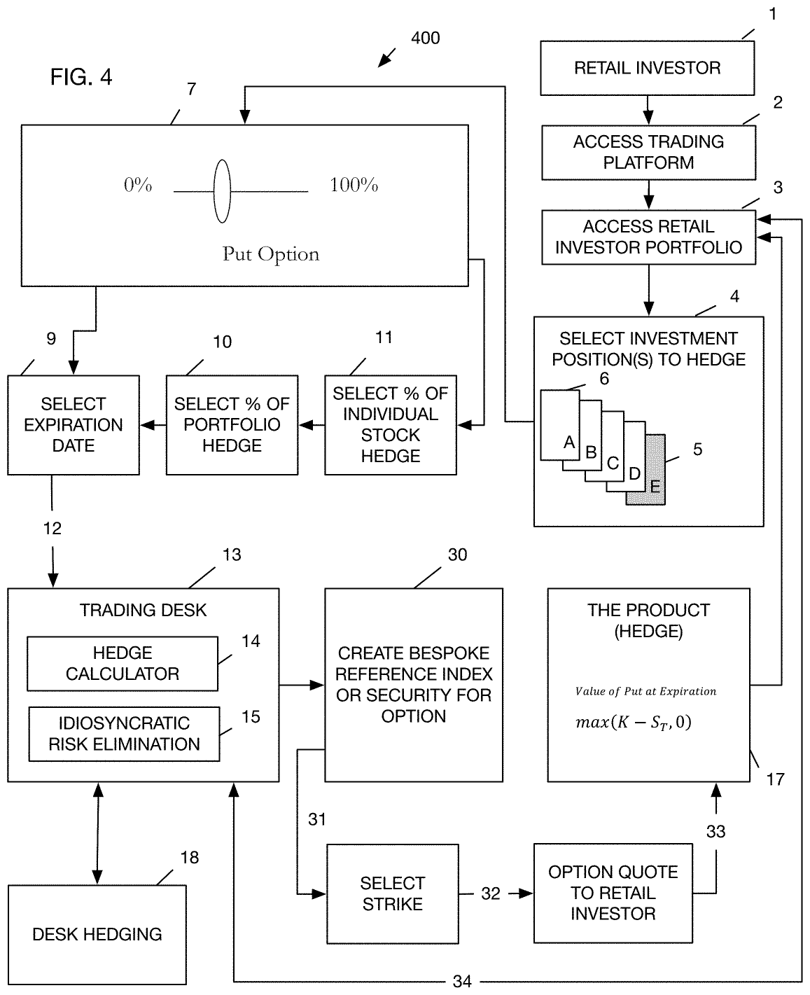

Another way for retail investors to scale risk in their portfolio is for them to use options as in FIG. 4. In this case, the system and process as described in FIG. 1 are largely the same, but the Product 17 at FIG. 4 is different. Instead of using a financial contract as in FIG. 1, a bespoke reference index as in FIG. 2, or a bespoke index security or asset as in FIG. 3, 17 FIG. 4 uses a put option on this bespoke asset. The retail investor can use 7 to select how much of their portfolio they want to protect with a put option and select the expiration date of the put option in 9. In one embodiment, the trading desk will create a bespoke reference index 30 that tracks the hedged portfolio for the option, where the reference index includes the investment positions the retail investor has selected to hedge. After the index is created and the current index level is calculated, the retail investor will select a strike price 31. After the strike is set, the retail investor will get a quote 32 for the right to sell the bespoke index created 30 at the selected strike price 31 on the selected expiration date 9. If the retail investor accepts the quote, the hedge 17 is issued 33 to the retail investor. The retail investor pays the option premium 34 to the trading desk and receives 34 the option value, if any, at the expiration of the option or when the option is unwinded (if an American-style put option).

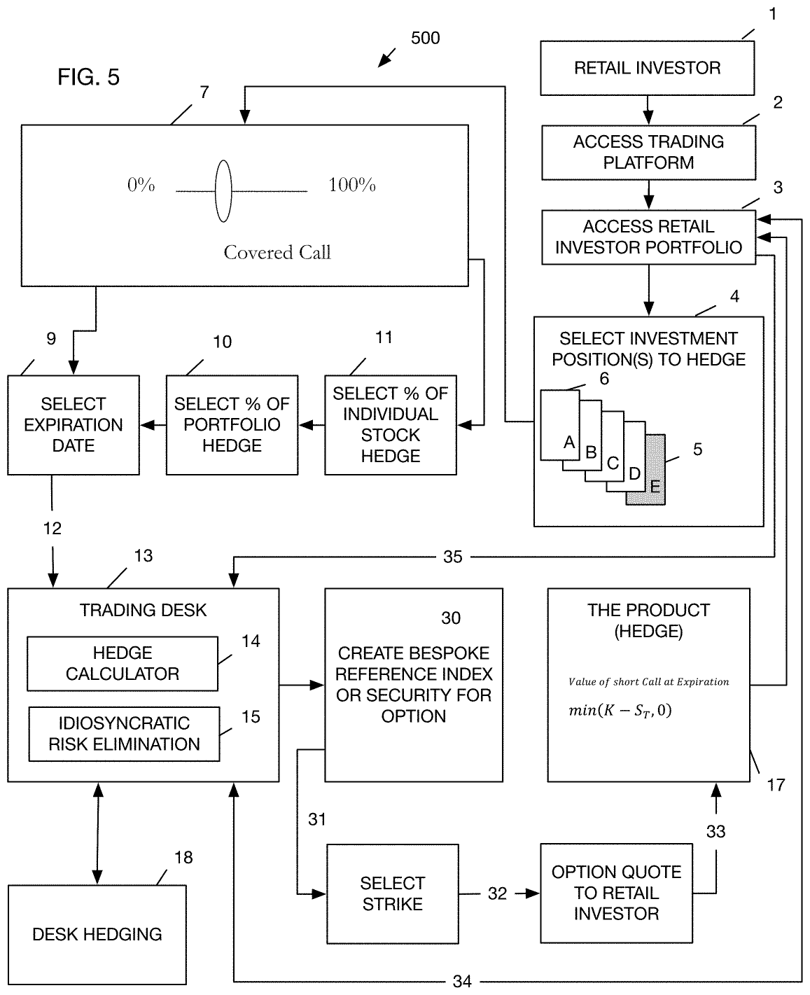

FIG. 5 is one embodiment of a trading platform 500 where investors can write covered calls on their portfolio (or parts of their portfolio) using a scaling system. The process is largely the same as the put option in FIG. 4, but the Product 17 FIG. 5 has a different payout as a covered call is a short call option on the reference index 30. The retail investor might have to post collateral 35 to the trading desk 13 or hold collateral in their retail brokerage account.

Today the concept of a Trading Desk 13 is migrating away from how a trading desk has traditionally been perceived. A significant part of trading today is done via electronic trading that has a high or full degree of automatization. A trading desk can even be just a trading software. Therefore, the trading itself might require little or no manual inputs from human traders at an actual desk or on a trading floor/pit. Trading Desk 13 refers to any electronic trading platform, trading software, a traditional trading desk, or any combination of the electronic trading platform, trading software, and a conventional trading desk.

The reference index 30 can be created from either long or short positions in the underlying equities (hedged positions). When the reference index uses short positions, the hedge 17 should be long the reference index, and when the reference index uses long positions, the hedge should be short the reference index.

The Product 17, as shown at FIGS. 1-5 is a financial product that hedges retail investors' equity portfolios. The Product 17 are designed to help position be perfectly offset by gains from the hedge calibrated to a 0% hedge error.

The “Risk Switch” refers to the on/off Product interface and what the user achieves by using The Product 17. Other examples of the name are “Reduce Risk,” “Hedge,” “Perfect Hedge,” “Zero Volatility,” “Zero Risk,” “Total Portfolio Protection,” “Portfolio Protection,” “Remove Exposure,” “Risk Scaling,” et cetera. Another example is for the interface to use a green button to represent an unhedged portfolio or stock and a red button to represent a hedged portfolio or stock or vice versa. Different versions or applications of the system allow for hedging a single stock, a family of stocks from a sector, or the entire portfolio of a trader.

The cost to hedge the portfolio using the invention could be any sum or nominal sum, for example, $5 per day, or even free, or a sum that varies with the size of the position being hedged. The financial contract 17 of FIG. 1, the bespoke reference index 17 of FIG. 2 hedge, and the bespoke asset or security hedge 17 FIG. 3 described in the contract details section below are three examples of a perfect hedge the Trading Desk 13 can provide to the retail investor. This can be any financial instrument that has a −1 correlation with the investment positions the retail investor wants to hedge.

Product Details

Product 17 is a financial contract, a position on a bespoke reference index, or a position on a bespoke asset or security. One example described below of an asset with a −1 correlation is a financial contract (17 FIG. 1), “the Risk Switch Hedge,” between the Retail Investor 1 and the Trading Desk 13. In this contract, the retail investor is the payer of the total return of their underlying portfolio, and the trading desk is the receiver. One difference between The Product 17 FIG. 1 and an equity swap is that The Product 17 does not need a funding leg. Another difference is that it does not need or have a fixed or set maturity.

An investor's dollar return from a stock investment follows a basic formula—the number of shares is multiplied by the difference between the purchase price and the current stock price. For example, if an investor bought 50 shares of Apple® at $175 and Apple® is now trading at $177, their profit is ($177−$175)*50=$100. Generally, the dollar return from a stock investment is given by:

(S_{T}−Sₜ)×Shares P/L from a stock investment

where S_{T}=current stock price, Sₜ=stock purchase price, Shares=number of shares

The basic idea is to create a financial contract, asset, or security that has the same return function as the stock but with a minus sign in front. The reason for the minus sign is that we want to make sure the two components move in opposite directions—if the investor loses money on their stock portfolio, it should be perfectly offset by the gains from their hedge and vice versa.

Therefore, The Product 17 payout is given by:

−(S_{T}−Sₜ)×Shares Value of Risk Switch Hedge

where S_{T}=current stock price, Sₜ=stock hedge level (price of stock when it was hedged), Shares=number of shares hedged

We remove the minus sign by changing the place of S(T) and S(t), and we get:

(Sₜ−S_{T})×Shares Value of Risk Switch Hedge

where S_{T}=Current stock price, Sₜ=Stock hedge level (price of stock when it was hedged), Shares=Number of Shares hedged

Most investors have at least a few stocks in their portfolio, and from what we have established so far, we can easily extend to any portfolio size. An investor with more than one stock in their portfolio can add the return from each stock to get their total return. Therefore, the return on a stock portfolio is given by:

$$P / L \text{from a portfolio of stocks}$$

$${\sum }_{i = 1}^{n} ( {S}_{i , T} - {S}_{i , t} ) \times {Shares}_{i}$$

$$where$$

$${S}_{i , T} = \text{current stock price for stock} i ,$$

$${S}_{i , t} = \text{stock purchase price for stock} i ,$$

$${Shares}_{i} = \text{number of shares of stock} i \text{in portfolio,}$$

$$n = \text{number of different stocks in the portfolio}$$

The only difference between the one stock example and a portfolio of stocks is adding the summation notation to the formula. If we do the same for The Product contract, we get the following formula for The Product 17 return.

$$\text{Value of Risk Switch hedge for a portfolio with several stocks}$$

$${\sum }_{i = 1}^{n} ( {S}_{i , t} - {S}_{i , T} ) \times {Shares}_{i}$$

$$where$$

$${S}_{i , T} = \text{current stock price for stock} i ,$$

$${S}_{i , t} = \text{stock purchase price for stock} i ,$$

$${Shares}_{i} = \text{number of shares of stock} i \text{in portfolio,}$$

$$n = \text{number of different stocks in the portfolio}$$

Since the goal for The Product hedge is to perfectly offset any fluctuations in the value of the investor's stock portfolio, we synthetically (no actual stock investment) create a contract with the exact opposite return as the underlying stock portfolio. The investor is still long on their underlying stock portfolio, but they are also short on the same portfolio from their hedge. The two return streams perfectly cancel out.

Another application of the invention lets retail investors hedge only the idiosyncratic risk in their portfolios. In this case, an index return is added to the above formula, for example, the return of the S&P 500 index. Specifically, if an investor wants to hedge $20,000 of idiosyncratic risk in their portfolio, the retail investor should receive the return on the S&P 500 index during the hedge period, in addition to the above formulas.

Investors can also use the scaling system and the Product to reduce risk instead of eliminating it. For example, if an investor has 100 shares of Apple®, 200 shares of IBM®, and 300 shares of Microsoft®, they can instruct their broker to hedge 40% of their portfolio. That means that they will keep 60% of their market exposure, and their portfolio (including the hedge) will change in value as if they own 60 shares of Apple®, 120 shares of IBM®, and 180 shares of Microsoft®.

This product application requires a change to our previous formula. The difference is that we now multiply the previous formula by a number between 0% and 100%. This number represents the amount of risk, in percentage terms, the investor wants to hedge. For instance, if the investor wants to hedge 40% of their portfolio, we simply multiply the formula by 40%.

$$\text{Value of Risk Switch hedge for a portfolio with several stocks when the investor hedges part of the portfolio}$$

$$( {\sum }_{i = 1}^{n} ( {S}_{i , t} - {S}_{i , T} ) \times {Shares}_{i} ) \times \% Hedge$$

$$where$$

$${S}_{i , T} = \text{current stock price for stock} i ,$$

$${S}_{i , t} = \text{hedge level for stock} i \text{(price of stock} i \text{at teh time of hedge)} ,$$

$${Shares}_{i} = \text{number of shares of stock} i \text{in poftfolio} ,$$

$$n = \text{number of different stocks in the portfolio} ,$$

$$\% Hedge = \text{percent of portfolio the investor hedged}$$

Investors can also use The Product 17 to hedge individual stocks by a different percentage amount. The only adjustment to the above formula is moving the % Hedge from outside the parentheses to inside. The value of The Product contract is then:

$${\sum }_{i = 1}^{n} ( {S}_{i , t} - {S}_{i , T} ) * {Shares}_{i} * \% {Hedge}_{i}$$

Another application of the invention lets retail investors increase risk in their portfolios by using a version of the dimmer in FIG. 6 that goes to, for example, 200%. In this case, the above payout functions are the same, but in cases where risk goes beyond 100%, there is a minus sign added before the % Hedge.

In an application that increases the risk for the investor, or if The Product is used to create a “synthetic ETF,” the contract in 17 will also have a funding leg.

An alternative to the financial contract described above is for the trading desk to create a reference index as in 30 FIG. 2. This reference index contains the stocks the retail investor has decided to hedge as per the combined hedge parameters 12 in FIG. 2. The investor has a short position in the reference index and receives any losses on this reference index portfolio, and pays any gains experienced during the life of the hedge. The index level is set at:

$$\text{Index Level}$$

$${\sum }_{i = 1}^{n} {S}_{i , T} \times {Shares}_{i}$$

$$where$$

$${S}_{i , T} = \text{current stock price for stock} i ,$$

$${Shares}_{i} = \text{number of shares hedged of stock} i \text{in retail portfolio} ,$$

$$n = \text{number of different stocks in the portfolio}$$

The trading desk can set S_{i,T} at the bid prices, the offer prices, or the mid prices for Sharesᵢ. The reference index can contain fractional stocks to mimic exactly the portfolio the investor decided to hedge. For example, the underlying position in Apple® can be 3 and ⅖ shares.

Another application of the invention lets retail investors hedge only the idiosyncratic risk in their portfolios. In this case, a short position (equal to the total sum of all hedged positions) in an index is added to the bespoke reference index, for example, the S&P 500 index.

Another option is for the trading desk to create (26 FIG. 3) a bespoke index security or asset that the retail investor could sell short. This index security contains the same underlying stocks the retail investor decided to hedge. The price of the security is:

$$\text{Bespoke Index Security Price}$$

$${\sum }_{i = 1}^{n} {S}_{i , T} \times {Shares}_{i}$$

$$where$$

$${S}_{i , T} = \text{current stock price for stock} i ,$$

$${Shares}_{i} = \text{number of shares hedged of stock} i \text{in retail portfolio} ,$$

$$n = \text{number of different stocks in the portfolio}$$

The trading desk can set S_{i,T} at the bid prices, the offer prices, or the mid prices for Sharesᵢ. The index security can contain fractional stocks to exactly mimic the portfolio the investor decided to hedge. For example, the underlying position in Apple® can be 3 and ⅖ shares.

Another application of the invention lets retail investors hedge only the idiosyncratic risk in their portfolios. In this case, a short position (equal to the total sum of all hedged positions) in an index is added to the bespoke asset or security, for example, the S&P 500 index.

FIG. 4 describes one embodiment of a trading platform where investors can buy put options on their portfolio. The Trading Desk 13 creates a reference index 30 as follows:

$$\text{Reference Index Level}$$

$${\sum }_{i = 1}^{n} {S}_{i , T} \times {Shares}_{i}$$

$$where$$

$${S}_{i , T} = \text{current stock price for stock} i ,$$

$${Shares}_{i} = \text{number of shares hedged of stock} i \text{in retail portfolio} ,$$

$$n = \text{number of different stocks in the portfolio}$$

The value of the put option at the option expiration is:

max(K−S_{T},0) Value of Put at Expiration

where K=Put Excercise Price, S_{T}=index level at expiration

The trading desk determines the value and price of the option before the option expiration by using any standard (i.e., Black and Scholes) or non-standard option pricing model, considering supply and demand for options, past market volatility, current market volatility, expected future market volatility, and all other factors affecting an option's price. The put option can be of European or American type. The hedge error for all European in the money put options is 0% when they expire. The hedge error for all American in the money put options is 0% when not exercised before the option expiration date.

FIG. 5 describes one embodiment of a trading platform where investors can sell covered call options on their portfolio. The Trading Desk 13 creates a reference index 30 as follows:

$$\text{Reference Index Level}$$

$${\sum }_{i = 1}^{n} {S}_{i , T} \times {Shares}_{i}$$

$$where$$

$${S}_{i , T} = \text{current stock price for stock} i ,$$

$${Shares}_{i} = \text{number of shares hedged of stock} i \text{in retail portfolio} ,$$

$$n = \text{number of different stocks in the portfolio}$$

The value of the short call option at the option expiration is:

min(K−S_{T},0) Value of short Call at Expiration

where K=Put Excercise Price, S_{T}=index level at expiration

The trading desk determines the value and the price of the option before the option expiration by using any standard or non-standard option pricing model, considering supply and demand for options, past market volatility, current market volatility, expected future market volatility, and all other factors affecting an option's price. The call option can be of European or American type.

### Examples

Investor A has a portfolio with eight different stocks. The portfolio is currently worth $95,000 and has the following details:

| Stock | Shares | Pri [symbol] | Stock Value |
|---|---|---|---|
| Apple | 50 | $176 | $8,800 |
| IBM | 100 | $132 | $13,200 |
| Tesla | 10 | $1,088 | $10,880 |
| Rivian | 100 | $80 | $8,000 |
| Facebook | 60 | $332 | $19,920 |
| Target | 50 | $226 | $11,300 |
| Citigroup | 100 | $64 | $6,400 |
| JP Morgan | 100 | $165 | $16,500 |
| | | Portfolio Value | $95,000 |

[symbol]

indicates data missing or illegible when filed

The investor becomes concerned about the effect a FED interest rate announcement due in the afternoon will have on their portfolio and decides to hit the “hedge button” on their broker's website (for example, Charles Schwab). The Trading Desk automatically issues a Risk Switch hedge 17 FIG. 1 that stipulates that the desk will pay investor A the following:

$$\text{Risk Switch Hedge Value}$$

$${\sum }_{i = 1}^{8} ( {S}_{i} ( t ) - {S}_{i} ( T ) ) ⋆ {Shares}_{i} = ( \$176 - Apple ( T ) ⋆ 50 + ( \$132 - I B M ( T ) ) ⋆ 100 + \$1 , 088 - Tesla ( T ) ) ⋆ 10 + ( \$80 - Rivian ( T ) ) ⋆ 100 + ( \$332 - Facebook ( T ) ) ⋆ 60 + ( \$226 - Target ( T ) ) ⋆ 50 + ( \$64 - Citigroup ( T ) ) ⋆ 100 + ( \$165 - \text{J P Morgan} ( T ) ) ⋆ 100$$

$$where Company ( T ) is the stock price of company at the expiration of the hedge .$$

Two days later, the investor again feels comfortable with the market conditions and unwinds their hedge. The market moved around a bit while the investor was hedged, and their stock portfolio fell in value by $1,980 to $93,020. By the time the investor unhedged their portfolio, the stocks were trading at these new levels:

| | | Pri [symbol] Hedge | |
|---|---|---|---|
| Stock | Shares | Expiration | Stock Value |
| Apple | 50 | $170 | $8,500 |
| IBM | 100 | $128 | $12,800 |
| Tesla | 10 | $1,092 | $10,920 |
| Rivian | 100 | $82 | $8,200 |
| Facebook | 60 | $310 | $18,600 |
| Target | 50 | $220 | $11,000 |
| Citigroup | 100 | $63 | $6,300 |
| JP Morgan | 100 | $167 | $16,700 |
| | | Portfolio Value | $93,020 |

[symbol]

indicates data missing or illegible when filed

While the investor's stock portfolio has decreased in value by $1,980, the investor has also made $1,980 from their Risk Switch hedge. The investor's gain on their Risk Switch hedge perfectly offsets losses in their portfolio, and their total account value is still $95,000. The payout the investor receives on their hedge is as follows:

Σᵢ₌₁^{B}(Sᵢ(t)−Sᵢ(T))*Sharesᵢ=($176−$170)*50+($132−$128)*100+($1,088−$1,092)*10+($80−$82)*100+($332−$310)*60+($226−$220)*50+($64−$63)*100+($165−$167)*100=$1,980 Risk Switch Hedge Value time T (hedge expiration)

where Company(T) is the stock price of company at the expiration of the hedge.

In another example, the investor uses The Product to reduce risk by 60% instead of eliminating it altogether. The Trading Desk and the investor enter a contract that pays as follows:

$$\text{Risk Switch Hedge Value}$$

$$( {\sum }_{i = 1}^{8} ( {S}_{i} ( t ) - {S}_{i} ( T ) ) ⋆ {Shares}_{i} ) ⋆ \% Hedge = ( ( \$176 - Apple ( T ) ⋆ 50 + ( \$132 - I B M ( T ) ) ⋆ 100 + \$1 , 088 - Tesla ( T ) ) ⋆ 10 + ( \$80 - Rivian ( T ) ) ⋆ 100 + ( \$332 - Facebook ( T ) ) ⋆ 60 + ( \$226 - Target ( T ) ) ⋆ 50 + ( \$64 - Citigroup ( T ) ) ⋆ 100 + ( \$165 - \text{J P Morgan} ( T ) ) ⋆ 100 ) ⋆ 60 \%$$

$$\text{where Company(} T \text{) is the stock price of company at the expiration of the hedge,}$$

$$\% Hedge = \text{percent of portfolio the investor hedges}$$

At the expiration of the hedge, the value of the contract is worth:

(Σᵢ₌₁^{B}(Sᵢ(t)−Sᵢ(T))*Sharesᵢ)*% Hedge=(($176−$170)*50+($132−$128)*100+($1,088−$1,092)*10+($80−$82)*100+($332−$310)*60+($226−$220)*50+($64−$63)*100+($165−$167)*100)*60%=$1,188 Risk Switch Hedge Value time T (hedge expiration)

where Company(T) is the stock price of company at the expiration of the hedge, % Hedge=percent of portfolio the investor hedges

In the last example, the investor reduces risk individually for each stock in their portfolio as per this chart:

| | | | Pri [symbol] Hedge | | Percentage |
|---|---|---|---|---|---|
| Stock | Shares | Pri [symbol] | Expiration | Stock Value | Hedge |
| Apple | 50 | $176 | $170 | $8,800 | 73% |
| IBM | 100 | $132 | $128 | $13,200 | 50% |
| Tesla | 10 | $1,088 | $1,092 | $10,880 | 0% |
| Rivian | 100 | $80 | $82 | $8,000 | 75% |
| Facebook | 60 | $332 | $310 | $19,920 | 100% |
| Target | 50 | $226 | $220 | $11,300 | 100% |
| Citigroup | 100 | $64 | $63 | $6,400 | 90% |
| JP Morgan | 100 | $165 | $167 | $16,500 | 25% |

[symbol]

indicates data missing or illegible when filed

The Trading Desk then writes a contract with the following payout:

$$\text{Risk Switch Hedge Value}$$

$${\sum }_{i = 1}^{8} ( {S}_{i} ( t ) - {S}_{i} ( T ) ) ⋆ {Shares}_{i} ⋆ \% {Hedge}_{i} ) = ( ( \$176 - Apple ( T ) ⋆ 50 ⋆ 73 \% + ( \$132 - I B M ( T ) ) ⋆ 100 ⋆ 50 \% + \$1 , 088 - Tesla ( T ) ) ⋆ 10 ⋆ 0 \% + ( \$80 - Rivian ( T ) ) ⋆ 100 ⋆ 75 \% + ( \$332 - Facebook ( T ) ) ⋆ 60 ⋆ 100 \% + ( \$226 - Target ( T ) ) ⋆ 50 ⋆ 100 \% + ( \$64 - Citigroup ( T ) ) ⋆ 100 ⋆ 90 \% + ( \$165 - \text{J P Morgan} ( T ) ) ⋆ 100 ⋆ 25 \% )$$

$$\text{where Company(} T \text{) is the stock price of company at the expiration of the hedge,}$$

$$\% {Hedge}_{i} = \text{percent of} {stock}_{i} \text{the investor hedges}$$

At the expiration of the hedge, the contract is worth:

$$\text{Risk Switch Hedge Value time} T \text{(hedge expiration)}$$

$${\sum }_{i = 1}^{8} ( {S}_{i} ( t ) - {S}_{i} ( T ) ) ⋆ {Shares}_{i} ⋆ \% {Hedge}_{i} ) = ( ( \$176 - Apple ( T ) ⋆ 50 ⋆ 73 \% + ( \$132 - I B M ( T ) ) ⋆ 100 ⋆ 50 \% + \$1 , 088 - Tesla ( T ) ) ⋆ 10 ⋆ 0 \% + ( \$80 - Rivian ( T ) ) ⋆ 100 ⋆ 75 \% + ( \$332 - Facebook ( T ) ) ⋆ 60 ⋆ 100 \% + ( \$226 - Target ( T ) ) ⋆ 50 ⋆ 100 \% + ( \$64 - Citigroup ( T ) ) ⋆ 100 ⋆ 90 \% + ( \$165 - \text{J P Morgan} ( T ) ) ⋆ 100 ⋆ 25 \% )$$

$$\text{where Company(} T \text{) is the stock price of company at the expiration of the hedge,}$$

$$\% {Hedge}_{i} = \text{percent of} {stock}_{i} \text{the investor hedges}$$

While platforms sometimes charge a fixed fee for performing a trade, the value of instruments is often variable upon the coverage received. We can calculate the value by replicating The Product contract with trades in the underlying securities and see how much this replication would cost. From the investor's perspective, the investor can replicate the trade by selling every stock in their portfolio and then buying them back later. Let us assume the retail investor has 15 different stocks in their portfolio with a total value of $35,000, and they want to hedge their position for five days. If the investor decides to sell their whole portfolio, they will turn their $35,000 stock investments into cash. They can then keep their $35,000 in an interest-bearing account. Five days later, when the investor wants to reenter the market, their $35,000 has increased to $35,000 plus five days' worth of interest on $35,000. If we assume a 1% interest, their account would be worth $35,005. Therefore, we can conclude that theoretical value tells us that The Product desk may pay the investor $5 for The Product.

Another way to arrive at the same answer is to look at it from the Trading Desk's perspective. We have seen that a perfect hedge of the desk's risk is a short version of the underlying portfolio. If the desk short (sells) each stock in the portfolio, the investor who buys the stock from the desk will pay them $35,000 for the stocks. The desk will then earn interest on $35,000 over five days. Assuming the same 1% interest, the desk is left with $5 in the end.

A third way to arrive at the theoretical value of The Product contract is to think of it in terms of the “floating” leg on a portfolio total return swap. Fair pricing of a total return swap calls for a second leg. In theory, the party who receives the total return of an asset should pay periodic interest for this revenue stream. The reason for this is that the party who pays the asset's total return will need to hedge that position by an investment in the underlying asset, and we can assume that they must borrow money to finance that purchase. The periodic interest revenue stream from the floating leg receiver is meant to cover the financing cost for the hedge.

We established earlier that the value of the financial contract (The Product, 17. FIG. 1) is as determined by this formula:

$$\text{Value of Risk Switch hedge for a portfolio with several stocks}$$

$${\sum }_{i = 1}^{n} ( {S}_{i , t} - {S}_{i , T} ) \times {Shares}_{i}$$

$${S}_{i , T} = \text{current stock price for stock} i ,$$

$${S}_{i , t} = \text{stock purchase price for stock} i ,$$

$${Shares}_{i} = \text{number of shares of stock} i \text{in portfolio,}$$

$$n = \text{number of different stocks in the portfolio}$$

Si(t), which represents the “hedge levels” or “strikes” for the stocks in the portfolio. Let's assume that an investor has a two-stock portfolio—100 shares of Apple® and 50 shares of Microsoft®. Apple® is currently trading at $176, and Microsoft® is trading at $304. Therefore, the total value of the investor's portfolio is $32,800. The investor wants to limit their downside and requests that their portfolio be automatically hedged should its value fall to $30,000. Two weeks later, the stock price for both Apple® and Microsoft® have suffered from poor consumer sentiment data, and the investor's $30,000 hedge request is eventually triggered as the stock price for Apple® falls to $160, and the stock price for Microsoft® drops to $260.

Once a hedge is triggered, the existing market prices determine each stock's actual hedge level (or strikes). The same principle applies to the buy and sell of stock in the underlying market. Just because Apple® last traded at $160 does not mean that an investor that decides to sell their Apple® stock will get $160. This is because it usually takes a few seconds between the time the sell order is triggered and when the trade is executed. The investor will probably sell their share very close to $160, and they might get $160, but the trade could also get done at a higher or lower level. Another analogy in the traditional stock market is the stop-loss sell order. A stop-loss sell order only guarantees that a market order is triggered once the stock reaches (or breaches) the stop loss level, not that the investor will sell their shares at the stop loss level. The actual trade might get done at a higher or lower level.

A trading desk might choose to hedge all or some of the underlying stocks in hedge 17 by taking positions in single names. In this case, the desk can pass along the prices from selling the stocks to the retail investor. For instance, if the desk shorts or sell Apple® at $160.25, the Apple® strike on The Product contract would also equal $160.25. When The Product desk manages its delta exposure with index instruments, the “last trade” in the market can determine The Product's strikes. The strikes for bespoke reference index 17 FIG. 2, FIG. 4-5, and for the bespoke security 17 FIG. 3 are determined the same way. They can be bid prices, mid prices, or offer prices.

The Product 17 FIG. 1-5 is, in one embodiment, indifferent to stock dividends. Let us assume that an investor holds one share of Apple®, which is currently trading at $176, and that Apple® will pay a $1 dividend tomorrow. The investor will achieve the same outcome if they decide to sell their shares today for $176 (and receive no dividend) as if they would achieve if they kept their stock (and received the dividend). This is because the stock price generally goes down by the dividend amount once paid. In the first scenario, the investor sells their Apple® share for $176, which they can buy back post dividend for $175. Their end position is a stock worth $1175 and $1 in cash, the same outcome they would achieve if they decided to keep their stock and wait for the dividend.

The Product works the same way. Again, let us assume that an investor has a “portfolio” with one share of Apple® that trades at $176. If the investor hedges their position with The Product, The Product contract will pay him ($176−Apple® Stock Price at the product expiration). Again, post dividend, the Apple® stock price will fall to $175. Therefore, the investor would lose $1 on their portfolio, but The Product contract will also be worth $1. In total, they will have a portfolio worth $175, plus $1 cash, which is the same position/amount they would have if they had decided to keep their Apple® position unhedged or if they had decided to replicate The Product in the underlying stock market.

The Trading Desk can afford to pay the investor $1 as the desk will receive the dividend, which equals $1. Of course, this is just one of two options. We can also let the investor keep the dividend directly, requiring a minor tweak to The Product payout formula. Other ways to handle dividends are also possible.

When retail customers use Product 17 FIG. 1, they enter a financial contract with a Trading Desk 13 FIG. 1. In this contract, the retail investor is the payer of the total return of their underlying portfolio, and the Trading Desk is the receiver. From a risk perspective, this is the same as if the Trading Desk buys the retail investor's entire portfolio, and therefore, the contract leaves the Trading Desk long delta. If the Trading Desk instead delivers a short position in a bespoke reference index FIG. 2 to the retail investor, or a bespoke asset or security FIG. 3, the risk is the same as for the financial contract FIG. 1.

Risk Management for the Trading Desk.

The invention pools many small retail portfolios together to eliminate all idiosyncratic risk. For instance, if 100,000 retail investors have switched off the risk in their portfolios, with an average portfolio size of $10,000, the Trading Desk will be long delta by $1 billion. This delta will be highly diversified as it contains small components from 100,000 different investor portfolios, and therefore, the portfolio will have minimal idiosyncratic risk.

The risk analysis for the Trading Desk 13 with a $1 billion client portfolio (combined position from all retail investor hedges) is reproduced below. As the desk's portfolio only contains minimal idiosyncratic risk, we will see that it is possible to hedge the customer portfolio with index instruments effectively. If the Trading Desk 13 hedges its entire $1 billion client portfolio with S&P 500 futures only, the desk's 95% VaR is $1.69 million, and the ETL is $2.36 million.

The desk's client portfolio looks like the overall market. Stocks with a high market capitalization are proportionally included in the portfolios investors hedge. The risk analysis primarily uses S&P 500 futures to hedge the client portfolio, which is effective in the absence of idiosyncratic risk. The delta from maturing client business offset the delta from new business. For example, if an investor switches off the risk in their $20,000 portfolio at the same time as another investor switches the risk back on in their $20,000 portfolio, the net change in the desk's delta is zero. As maturing trades (investors turning the risk back on) offset the delta from new business (investors turning the risk “off”), the desk will be left to manage only the fluctuations in its total delta position.

The desk's $1 billion position is broken into 1,495 components (the 1,495 stocks in the S&P 1500 with at least one year of daily historical data) and give each stock a weight according to its weight in the S&P 1500 index. We multiply the weight for each stock by $1 billion to get the actual notional for each stock. To calculate the size of the index hedge, we multiply each stock's position by its market beta (all results are close to identical without a beta adjustment). The 95% VaR is $1.00 million in this base case scenario, and the ETL is $1.34 million.

The desk's $1 billion portfolio will not break down exactly according to the weights in the underlying market. A second scenario uses the base scenario as a starting point but allows the weight for each stock to randomly fluctuate between zero and two times the weight given in the base scenario. For example, Apple's weight in the base case scenario is 5.47%, which equals a $54.70 million notional. In this scenario, the notional for Apple® will randomly fluctuate between $0 and $109.40 million. With each outcome as likely, Apple's average “open” position is $27.35 million when the entire $1 billion client portfolio is hedged with S&P 500 futures. We simulated 5,000 different $1 billion client portfolios, and the average 95% VaR is $1.69 million. The standard deviation of the results for the 5,000 VaR simulations is $0.45 million. The average ETL for the 5,000 simulations is $2.30 million. We then hedge the desk's risk effectively with S&P 500 futures only, even in a case when we allow the delta for each stock to fluctuate significantly away from the “expected” delta. The overall portfolio is still highly diversified, and it contains little idiosyncratic risk.

A VaR Waterfall analysis identified the five stocks (of the 1495 stocks in total) that had the most significant impact on VaR (in each of the 5,000 simulations). Hedging those individual names so that their deltas' size was in line with the size of the index position. For instance, if we had $70 million in AAPL delta in the client portfolio, we hedged $45.65 million of AAPL to get the total delta down to 5.47% of the portfolio total (equal to its weight in the S&P 500 index). We only hedged five names, but VaR was still reduced by 41.12% to $0.99 million and ETL by 36.25% to $1.47 million.

Another scenario looks at the risk impact if investors' portfolios are overrepresented with small-cap stocks. In this scenario, we use the base case scenario as a starting point, but we also allow the weights for the 10% of the smallest stocks to randomly fluctuate between 0 and 10 times the weights in the base case scenario. The total notional in the base case scenario for the 10% smallest stocks is only $2.23 million. Still, in this scenario, the average total notional for those stocks is $13.00 million, leaving a $10.77 million “open” position in small-cap stocks.

After simulated 5,000 different outcomes, and the average 95% VaR is $1.21 million when the entire client portfolio is hedged with S&P 500 futures only. The standard deviation of the results for the 5,000 simulations is $0.01 million. The average ETL for the 5,000 simulations is $1.60 million. It is possible to hedge the desk's risk effectively with S&P 500 futures only, even when there is a significant overrepresentation of small-cap stocks.

The invention also works with investors' portfolios overrepresented with large-cap stocks. We use the base case scenario as a starting point, but we allow the weights for the 10% largest stocks to randomly fluctuate between 0 and 10 times the weights in the base case scenario. The total notional in the base case scenario for the 10% largest stocks is $0.72 billion. In this scenario, the average total notional for those stocks is $0.93 billion, leaving a significant “open” position in large-cap stocks, and effectively, almost no client hedging in the stocks beyond the 10% largest stocks. We simulated 5,000 different client portfolios, and the average 95% VaR is $1.91 million when the total client portfolio is hedged with S&P 500 futures only. The standard deviation of the results for the 5,000 simulations is $0.44 million. The average ETL for the 50,000 simulations is $2.79 million. It is possible to hedge the desk's risk effectively with S&P 500 futures only, even with a significant overrepresentation of large-cap stocks. The same VaR waterfall analysis as above reduced VaR by 54.77% to $0.86 million and ETL by 52.86% to $1.32 million.

The same is true if a client's portfolio has extensive industry concentration. We analyzed the results for nine different industries, and in each case, we used the base case scenario as a starting point, but we allowed the weights for the stocks in the industry to randomly fluctuate between 0 and 10 times the weights in the base case scenario. These scenarios added a significant industry delta to our $1 billion client portfolio, and therefore, the basis between the client portfolio and an S&P 500 index hedge increased. However, in the most extreme industry scenario, on average, we added $0.19 billion of “banks” delta compared to the base case delta, and the average 95% VaR in the “banks scenario” from our 5,000 simulations is $4.60 million when the entire client portfolio is hedged with S&P 500 futures only. The standard deviation of the results for the 5,000 simulations is $0.56 million, and the average ETL is $6.60 million. In practice, it would, of course, not make sense to leave a $0.19 billion “open” basis position between banks and S&P 500 futures, so we completed a VaR Waterfall analysis to identify the five bank stocks in the client portfolio that had the most significant impact on the total risk. After hedging only those five names (by reducing the delta for those names down to the base delta), the 95% VaR was decreased by 46.02% to $2.48 million, and the ETL was reduced by 45.96% to $3.56 million. The desk's risk effectively covered with only S&P 500 futures while maintaining a good revenue vs. risk ratio. However, if there is a large concentration of industry delta, the Trading Desk can substantially reduce the industry risk by adding single name hedges.

Counterparty Risk

The investor's stock portfolio serving as collateral, there are no scenarios in which the investor is unable to close out their hedge. As an extreme example, assume that an investor is hedging their $20,000 portfolio. Five days later, the value of their portfolio has increased to $1,000,000, which means that a $980,000 payment is required to close out the hedge. As expected, the investor will still have $20,000 left after making this payment as their portfolio (excluding the hedge) is worth $1,000,000.

Suppose the invention is used to increase the risk to, for example, 200%. In that case, the retail investor may put up collateral (cash, assets, or securities) for their additional market exposure or fund all or a percentage of their additional exposure. For example, suppose the investor increases their total market exposure by $10,000. In that case, they might have to provide only $5,000 in funding and additional funding due to the daily mark to market of their investments.

Tax Implications In the mid-'90s, Congress realized that taxpayers used different derivatives to effectively close out an appreciated financial asset while avoiding paying capital gains taxes. To curb these practices, Congress enacted Internal Revenue Code, Section 1259 in 1997. The new code was designed to prevent a taxpayer from entering long-term hedging transactions that would defer capital gains indefinitely, or transfer gains from one tax period to another, while substantially reducing or eliminating the risk of loss. The new code provides “constructive sale” treatment for appreciated financial positions. According to this rule, transactions that effectively take an offsetting position to an already owned position are constructive sales. In general, if there is a constructive sale of an appreciated financial position, the taxpayer must recognize gain as if such position were sold, assigned, or otherwise terminated at its fair market value on the date of such constructive sale, and any gain must be considered for the taxable year.

However, there are important exceptions to the constructive sale rule. The closed transaction exception, or the short-term hedge exception, section 1259(c)(3)(A) of the Internal Revenue Code, stipulates that the constructive sales rule does not apply when the substantially similar position is closed on or before the 30th day after the close of the taxable year. The taxpayer holds the appreciated financial position throughout the 60 days beginning on the date such transaction is closed. At no time during the 60 days is the taxpayer's risk of loss concerning such position reduced again. Section 1259(c)(3)(B) stipulates that if a transaction, which would otherwise cause a constructive sale, is closed and reestablished with a substantially identical position, the closed transaction exception should still apply provided that the reestablished substantially identical position is closed before the 30th day after the close of the taxable year, and, after that closing, the 60-day rule is not violated.

Therefore, the two exceptions to section 1259 regarding constructive sale—the closed transaction section 1259(c)(3)(A), and the exception to the closed transaction exception, section 1259(c)(3)(B)—give investors the ability to use The Product 17 FIG. 1-3 without causing a constructive sale of their entire portfolio.

Settlements

The purpose of the Hedge 17 is to offset any fluctuations in the investor's stock portfolio. A loss in the portfolio would be perfectly offset by a gain on the hedge, and a gain in the portfolio would be offset by a loss on the hedge. Therefore, once the hedge expires, the retail investor will either make or receive a payment from the Trading Desk. For example, let us assume that an investor with a total portfolio value of $40,000 decided to hedge their position for five days while away on vacation. Let us also assume that their portfolio lost $3,500 during these five days. Consequently, once the contract expired, Trading Desk 17 would make a $3,500 payment to the investor, which means their total account value remains $40,000. A second example is if the portfolio increased in value. For instance, let us assume that the investor's stock portfolio increased to $41,500 after five days. In this scenario, the investor would make a $1,500 payment to the Trading Desk, bringing their total account value to $40,000.

Product 17 can be settled at the expiration of the hedge, but the value of the hedge can also be settled daily, weekly, et cetera. The first way to settle the Hedge 17 at expiration is to use cash. That means that Trading Desk 13 would send or receive cash from Investor 1 to settle the contract. Payment from the Trading Desk 13 would be added to the investor's cash balance, and a payment from the investor is taken from either their cash or margin account.

A second way to settle the Hedge 17 is by adjusting the investor's number of shares in each stock. That way, a $10,000 position in Apple® before the hedge would translate into a $10,000 position in Apple® after the hedge. The dollar value in each stock remains the same, while the number of shares is adjusted. A third alternative is to use a combination of cash and stock settlement. The options 17 FIG. 4-5 can be settled with cash.

FIG. 15 helps to illustrate the distinction between FIGS. 1, 2, and 3 and the role they play as part of the overall inventive concept. It illustrates generally how each stock A, B, or C alone or as part of a portfolio fluctuates in value either from general market events 81 or can fluctuate in value because of a movement that is from a specific event 82. For example, a Federal Reserve announcement or a new war declaration by a government creates systematic risk or market risk 83 as entire groups of stocks, even the entire market as a whole will move. In contrast, an idiosyncratic risk aka an unsystematic risk such as the forced retirement of a CEO or a product recall will create limited risk 84 of a different type that only affects individual companies (idiosyncratic risk).

The inventor has noted that market risk 83, as it relates to large baskets of stocks moving either upwards or downwards in some coordinated fashion, the prices move in a correlated fashion across all companies 85. This results in a risk that can be easily hedged by simply taking a commonly created hedge linked with indexes. For example, the S&P 500 actually includes around 505 stocks each in different proportions. As of Feb. 17, 2022, the weight of the top 10 stocks is Apple® at 7.11%, Microsoft® at 5.95%, Amazon® at 3.6%, Google A & B at 5.4%, Tesla® at 2%, NVIDIA® 1.7%, Berkshire® at 1.5%, Meta® at 1.4%, and JPMorgan Chase® at 1.2% for a combined total of around 30% of the S&P Index.

If one day an event rocks the market and creates a systematic risk or market risk 83, for example, the general S&P Index might slide 3% down. A financial product exists, a S&P 500 Futures (ticker: SP) which is a contract with a minimum tick of 0.25 points (Exists also are E-mini S&P futures). This product allows to be purchased 87 and hedge the systematic risk or market risk. The inventor explains that this is a hedgeable risk 87 that can easily be provided by others. This invention in contrast factors both this market risk 83 but also the idiosyncratic risk 84 linked with individual movements of uncorrelated stock prices 86 as shown at FIG. 15.

The inventor understands that while market risk 83 can easily be covered using a single hedge like the S&P hedge for a cost, the uncorrelated risk or the idiosyncratic risk 84 is much more difficult to cover effectively.

As part of the unhedgeable risk 88, linked with individual movements, the market risk instrument like SP would not align and correlate with the movements. As a consequence, the inventor has created in the system described above algorithms to cover unhedgeable risk 88 making it hedgeable as long as new tools are created 90.

The inventor's invention is optimized in the range it considers “retail” where the number of stocks or positions are limited. Most retail positions may not have hedges to secure in a correlated or aligned fashion and retail investors' portfolios often contains idiosyncratic risk. For example, a stock like Amazon® is very expensive at $3200 each, and a put option hedge contracts are only sold for positions of 100 stocks. A retail Amazon® investor often does not have 100 Amazon® shares or $320,000 worth of Amazon® stocks in their portfolio. With respect to idiosyncratic risk, a retail investor often has a limited number of different stocks in their portfolio, for example, less than 30. Therefore, it contains a significant amount of idiosyncratic risk 84 that is unhedgeable 88 with other existing financial products. A problem in the area of “non-retail”, for example, hedge funds, insurance companies, or other institutional investors, is that their exposure can be too large and/or too concentrated for a hedge provider or trading desk 13 to easily take on such concentrated and or large risk as the counterparty on the hedge contract. For example, if a hedge fund wants to hedge $10 billions of Apple® exposure, a trading desk 13 might not immediately be able to provide a hedge 17 for such a large position. Such a large, concentrated positions may take hours or days to fully sell, buy or hedge. Retail investors' portfolios are not too concentrated or too large to handle for the trading desk 13.

Investopedia's definition of a retail investor is as follows: “A retail investor, also known as an individual investor, is a non-professional investor who buys and sells securities or funds that contain a basket of securities such as mutual funds and exchange traded funds (ETFs). Retail investors execute their trades through traditional or online brokerage firms or other types of investment accounts. Retail investors purchase securities for their own personal accounts and often trade in dramatically smaller amounts as compared to institutional investors. An institutional investor is an umbrella term for larger-scale investments by professional portfolio and fund managers who might manage a mutual fund or pension fund. The retail investment market is enormous since it includes retirement accounts, brokerage firms, online trading, and robo-advisors. Retail investors usually buy and sell trades in the equity and bond markets and tend to invest much smaller amounts than large institutional investors.”

A person that works in the financial industry in a professional capacity (for example a trader at an investment bank) is considered a retail investor when they trade for their own account.

A new bespoke product is then created 90 that hedges both market and idiosyncratic risk, such as a single new financial product 91 designed to directly correlate with the position to be hedges, covering both idiosyncratic risk 84 and market risk 83. The system is designed to create new financial contracts 93, a new reference indexes 94 or a new asset or security 95 which has a 1 or −1 correlation 92 with the position to be hedged.

As part of the creation of a financial contract 93, reference index 94, or asset or security 95, one of ordinary skill in the art understands that each contract 93, reference index 94 or asset or security 95, is a different financial contract 93, reference index 94 or asset or security 95 is built based on different parameters reflecting the portfolio to be hedged. The inventor has created a new correlated financial contract 93, reference index 94, asset or security 95 built with a 1 or −1 correlation that is created based on a variability of the positions. For example, if a party owns 10 Ford® (10×$18=$180), 20 General Motor® (20×$48=$960), and 2 Tesla® stocks (2×$845=$1690), a financial contract, reference index, security or asset will be built to be purchased or sold to cover the variability associated with this set of positions. For example, if all 3 positions move down 5% because the automobile sector goes down, the hedged contract has to pay out 5% of the value (i.e. $141.50). In contrast, if the positions go up, the hedge transaction will benefit the seller of the hedge.

The value change is often defined as above or as F(x)=Δ1+Δ2+Δ3 where F(x) is the variation of the new contract, reference index, asset or security which is a summation of the variation of each of three stocks (here Ford® (Δ1), General Motor® (Δ2), and Tesla® (Δ3)). Since the system is designed to help hedge specific risk and not generate money for the portfolio owner (except for the covered call in FIG. 5), one of ordinary skill in the art will understand the new contract, reference index, asset or security built internally in the system will match a specific variability. In truth, since historically the market has moved progressively up and not down over the past decades, generating a return of several percent per year, when risk it hedged, even in small increments of time, in average upper movements occur as often as lower movements. For example, if a portfolio is fully hedged and the positions go down by 5%, the hedge will pay $141.50 to the user. But if the fully hedged portfolio sees the value of the stocks raise, the fully hedged individual will have the value of the portfolio locked and the added rise will be generated by the system to compensate for the service offered. In the above, the value of an instrument generating $141.50 in FIGS. 1-3 in case of a drop of 5% will generate $141.50 for the system in case of a 5% rise in value for the hedged portion. One of ordinary skill in the art will understand how the creation of a financial contract, as shown at FIG. 1 96 interplays with the new process and system described here.

What is also contemplated is a situation where, instead of creating a new financial contract 93, a reference index is created 94. The name “reference index” refers to a collection of stocks, and the name could be any other that means it contain a stock or a collection of stocks, for example, “reference portfolio”. As described above, the S&P 500 is only one of numerous indexes that exist. Other famous and well-known indexes include the DOW and the NASDAQ. An index, as described is simply a listing of stocks that exist often in different scaled proportions. In the above, the S&P 500 is shown to have 7.11% of Apple® Stock. The inventor contemplates to alternatively create a new index, where in the above example this index would be formed with 3 stocks (Ford®, General Motor® and Tesla®). The ratio of the stocks would be as the ratio found in the underlying portfolio for example Ford® at 6.36%, (i.e. $180/$2830=0.0636), General Motor® at 33.92% (i.e. $960/$2830=0.3392), and Tesla® at 59.72% (i.e. $1690/$2830=0.5972). Once such an index is created, the hedge is offered and taken directly on this index.

The third is the creation of a new asset or security 95, for example one with a CUSIP number that is in fact a basket of assets, much like a Fund having relevant value proportional to the portfolio positions. In the creation of this new asset or security 95, the assets would be for example 10 shares of Ford®, 20 shares of General Motor® and 2 shares of Tesla® under the new name FGMTES. The value of this asset or security would be proportional to the value of the sum of the three underlying securities. In this case, since the underlying prices are transparent, the inventor believes the new asset or security created would not require trading in the secondary market but can trade and provide a hedged simply as any other security.

Now that the above is described, as part of the claimed subject matter described hereafter, the inventor claims a system for the elimination or scaling of risk of an equity portfolio using a trading platform, the system comprising a personal trading computer with a memory and a central processing unit in functional communication with the memory for executing software in the central processing unit for accessing by an investor using the personal computer a trading platform for access, display and trading a plurality of investment positions, the plurality of investment positions forming an investor portfolio with a number of investment positions, the trading platform located on a remote server in communication with each of a plurality of personal trading computers, including the personal trading computer of the investor, the server with a second memory and a second central processing unit with software for trading on a trading desk a plurality of user portfolio each with a number of investment positions, the trading platform in trading communication for the acquisition, purchase, sale and storage of both investment positions and hedge positions, wherein the trading platform on the personal trading computer includes one of a risk switch for the selection and toggle by the user between a non-hedged risk and a fully-hedged risk, or a risk dimmer toggle for selection by the user of a variable-hedged risk ranging from a non-hedged risk to a fully-hedged risk, wherein the trading platform located on the remote server using the risk switch selection or the risk dimmer toggle uses a trading desk with a hedge calculator for the calculation of a product hedge with idiosyncratic risk elimination, and wherein the trading platform acquires on behalf of the investor the product hedge with idiosyncratic risk elimination for offset of any potential loss in the investor portfolio.

In a different embodiment, we also claim the above but wherein the trading desk with the hedge calculator for the calculation of the product hedge with idiosyncratic risk and market risk elimination, includes a selection of the product hedge from a group consisting of a custom built financial contract based on the positions in the investor portfolio, a custom built reference index based on the financial positions in the investor portfolio, or a custom built asset or security based on the financial positions in the investor portfolio.

In the above, we also claim the system wherein the risk dimmer toggle offers a number of regular risk increments from 0% (non-hedged risk) to 100% (fully-hedged risk) in a group consisting, continuous increments, 1% increments, 5% increments, 10% increments, 20% increments, 33⅓% increments or 50% increments and wherein the hedge error is 0%. Also, the above describes wherein the risk switch for the selection by the user of a non-hedged risk or a fully-hedged risk, or the risk dimmer toggle for selection by the user of a variable-hedged risk ranging from a non-hedged risk to a fully-hedged risk can be untoggled or unswitched to alternate between a previously selected risk level to a previously-selected risk level.

In another embodiment, the above system is claimed wherein the risk switch for the selection by the user of a non-hedged risk or a fully-hedged risk, or the risk dimmer toggle for selection by the user of a variable-hedged risk ranging from a non-hedged risk to a fully-hedged risk allows for the selection and use by the trading desk of one of (a) a selected duration of hedge, (b) a selected percentage of portfolio hedge, or (c) a selected number of individual stocks to hedge or wherein the risk switch and/or the risk dimmer toggle can be turned on or off and at such even, the prior hedge is closed, the position is paid and normal trading can resume with assumption of risk. In a final claimed version of the system, also includes a selection of a mode where idiosyncratic risk and/or market risk is reduced by acquisition of two separate hedges, one for idiosyncratic risk and one for market risk.

Similarly, using the above system, we also claim a method of generating a hedge for the elimination of market risk and idiosyncratic risk of an equity portfolio with a system using a trading platform, the method comprising the steps of allowing a retail equity investor or other type of equity investor to access the trading platform and their investor portfolio; accessing either of a risk switch or a risk dimmer toggle to hedge the investor portfolio; and allowing a hedge calculator in a trading desk to eliminate market risk and idiosyncratic risk using a desk hedging tool connected to market equity to generate a product hedge.

Also the method may further comprises the step of selecting one of a duration of hedge, a percentage of the investor portfolio to hedge, and a percentage of individual stocks to hedge and using the product hedge to eliminate the market risk and idiosyncratic risk in the investor portfolio by payment using the hedge of any losses in the investor portfolio at the height of the covered portion selected.

Finally, the methods also include the step of allowing a user to remove the hedge selected and by payment at the removal time of the hedge of the covered risk. Also wherein the trading desk with the hedge calculator for the calculation of the product hedge with idiosyncratic risk elimination, includes a selection of the product hedge from a group consisting of a custom built financial contract based on the positions in the investor portfolio, a custom built reference index based on the financial positions in the investor portfolio, or a custom built asset or security based on the financial positions in the investor portfolio, and wherein the method includes the step of selecting from one of the custom built financial contract based on the positions in the investor portfolio, the custom built reference index based on the financial positions in the investor portfolio, or the custom built asset or security based on the financial positions in the investor portfolio.

1. A system for the elimination or scaling of risk of an equity portfolio using a trading platform, the system comprising:
a personal trading computer with a memory and a central processing unit in functional communication with the memory for executing software in the central processing unit for accessing by a user using the personal computer a trading platform for access, display and trading a plurality of investment positions, the plurality of investment positions forming an investor portfolio with a number of investment positions;
the trading platform located on a remote server in communication with each of a plurality of personal trading computers, including the personal trading computer of the user, the server with a second memory and a second central processing unit with software for trading on a trading desk a plurality of user portfolio each with a number of investment positions; the trading platform in trading communication for the acquisition, purchase, sale and storage of both investment positions and hedge positions;
wherein a user interface on the trading platform includes one of a risk switch for the selection and toggle by the user between a non-hedged risk and a fully-hedged risk, or a risk dimmer toggle for selection by the user of a variable-hedged risk ranging from a non-hedged risk to a fully-hedged risk;
wherein the trading platform located on the remote server using the risk switch selection or the risk dimmer toggle uses a trading desk with a hedge calculator for the calculation of a product hedge comprising an individualized financial asset with market risk and idiosyncratic risk elimination based on the user-selected variable-hedged risk; and
wherein the trading platform acquires on behalf of the user the product hedge with idiosyncratic risk elimination for offset of any potential loss in the investor portfolio.

2. The system for the elimination or scaling of risk of an equity portfolio using a trading platform of claim 1, wherein the trading desk with the hedge calculator for the calculation of the product hedge with idiosyncratic risk elimination, includes a selection of the product hedge from a group consisting of: a custom built financial contract based on the positions in the investor portfolio, a custom built reference index based on the financial positions in the investor portfolio, or a custom built asset or security based on the financial positions in the investor portfolio.

3. The system for the elimination or scaling of risk of an equity portfolio using a trading platform of claim 2, wherein the risk dimmer toggle is adjustable between a number of regular risk increments from 0% (non-hedged risk) to 100% (fully-hedged risk) in a group consisting, 1% increments, 5% increments, 10% increments, 20% increments, 33⅓% increments or 50% increments.

4. The system for the elimination or scaling of risk of an equity portfolio using a trading platform of claim 3, wherein the hedge error is 0%.

5. The system for the elimination or scaling of risk of an equity portfolio using a trading platform of claim 4, wherein the risk switch for the selection by the user of a non-hedged risk or a fully-hedged risk, or the risk dimmer toggle for selection by the user of a variable-hedged risk ranging from a non-hedged risk to a fully-hedged risk can be untoggled or unswitched to alternate between a first risk level to a different second risk level.

6. The system for the elimination or scaling of risk of an equity portfolio using a trading platform of claim 1, wherein the risk switch for the selection by the user of a non-hedged risk or a fully-hedged risk, or the risk dimmer toggle for selection by the user of a variable-hedged risk ranging from a non-hedged risk to a fully-hedged risk allows for the selection and use by the trading desk of one of (a) a selected duration of hedge, (b) a selected percentage of portfolio hedge, or (c) a selected number of individual stocks to hedge.

7. The system for the elimination or scaling of risk of an equity portfolio using a trading platform of claim 2, wherein the risk switch and/or the risk dimmer toggle can be turned on or off and at such even, the prior hedge is closed, the position is paid and normal trading can resume with assumption of risk.

8. A method of generating a hedge for the elimination of market risk and idiosyncratic risk of an equity portfolio with a system using a trading platform, the system comprising a personal trading computer with a memory and a central processing unit in functional communication with the memory for executing software in the central processing unit for accessing by a user using the personal computer a trading platform for access, display and trading a plurality of investment positions, the plurality of investment positions forming an investor portfolio with a number of investment positions, the trading platform located on a remote server in communication with each of a plurality of personal trading computers, including the personal trading computer of the user, the server with a second memory and a second central processing unit with software for trading on a trading desk a plurality of user portfolio each with a number of investment positions; the trading platform in trading communication for the acquisition, purchase, sale and storage of both investment positions and hedge positions, wherein a user interface on the trading platform includes a risk switch for the selection and toggle by the user between a non-hedged risk and a fully-hedged risk, and a risk dimmer toggle for selection by the user of a variable-hedged risk ranging from a non-hedged risk to a fully-hedged risk, wherein the trading platform located on the remote server using the risk switch selection or the risk dimmer toggle uses a trading desk with a hedge calculator for the calculation of a product hedge comprising an individualized financial asset with market risk and idiosyncratic risk elimination based on the user-selected variable-hedged risk, and wherein the trading platform acquires on behalf of the user the product hedge with market risk and idiosyncratic risk elimination for offset of any potential loss in the investor portfolio, the method comprising the steps of:
allowing the user to access the trading platform and his or her investor portfolio;
displaying either of the risk switch or the risk dimmer toggle to hedge the investor portfolio; and
allowing a hedge calculator in a trading desk to eliminate idiosyncratic risk using a desk hedging tool connected to market equity to generate a product hedge.

9. The method of generating a hedge for the elimination of market risk and idiosyncratic risk of an equity portfolio with a system using a trading platform of claim 8, wherein the method further comprises the step of selecting one of a duration of hedge, a percentage of the investor portfolio to hedge, and a percentage of individual stocks to hedge.

10. The method of generating a hedge for the elimination of market risk and idiosyncratic risk of an equity portfolio with a system using a trading platform of claim 8, wherein the method further comprises the steps of using the product hedge to eliminate the idiosyncratic risk in the investor portfolio by payment using the hedge of any losses in the investor portfolio at the height of the covered portion selected.

11. The method of generating a hedge for the elimination of market risk and idiosyncratic risk of an equity portfolio with a system using a trading platform of claim 10, wherein the method further comprises the step of allowing a user to remove the hedge selected and by payment at the removal time of the hedge of the covered risk.

12. The method of generating a hedge for the elimination of market risk and idiosyncratic risk of an equity portfolio with a system using a trading platform of claim 10, wherein the trading desk with the hedge calculator for the calculation of the product hedge with idiosyncratic risk elimination, includes a selection of the product hedge from a group consisting of: a custom built financial contract based on the positions in the investor portfolio, a custom built reference index based on the financial positions in the investor portfolio, or a custom built asset or security based on the financial positions in the investor portfolio, and wherein the method includes the step of selecting from one of the custom built financial contract based on the positions in the investor portfolio, the custom built reference index based on the financial positions in the investor portfolio, or the custom built asset or security based on the financial positions in the investor portfolio.

13. The method of generating a hedge for the elimination of market risk and idiosyncratic risk of an equity portfolio with a system using a trading platform of claim 15, wherein the risk dimmer toggle is adjustable between a number of regular risk increments from 0% (non-hedged risk) to 100% (fully-hedged risk) in a group consisting, 1% increments, 5% increments, 10% increments, 20% increments, 33⅓% increments or 50% increments.

14. The method of generating a hedge for the elimination of market risk and idiosyncratic risk of an equity portfolio with a system using a trading platform of claim 13, wherein the hedge error is 0%.

15. The system of claim 1, wherein the individualized financial asset comprises a newly-created bespoke financial asset.

16. The system of claim 1, wherein the risk switch is configured to temporarily eliminate risk when selected by the user for a customized period of time.

17. The system of claim 15, wherein the individualized financial asset transfers risk to a third-party for a risk level selected by the user using the risk switch and the risk dimmer toggle via the newly created bespoke financial asset.

18. The system of claim 1, wherein the product hedge achieves a −1 correlation to the investor portfolio.

19. The system of claim 1, wherein the product hedge does not require the user to buy or sell investment positions in the investor portfolio.

20. The system of claim 1, wherein the product hedge temporarily eliminates all risk in the investor portfolio including upside risk, downside risk, idiosyncratic risk, and market risk.
